(19) United States
(12) Patent Application Publication
(10) Pub. No.: US 2026/0270494 A1
(43) Pub. Date: Sep. 10, 2026

(54) MITIGATING MOTION SICKNESS FOR SPECTATORS IN GAMEPLAY SESSIONS

(71) Applicant: Adeia Guides Inc., San Jose, CA (US)

(72) Inventors: Christopher Phillips, Hartwell, GA (US); Tao Chen, Palo Alto, CA (US); Reda Harb, Saint Petersburg, FL (US); Charles Dasher, Lawrenceville, GA (US)

(21) Appl. No.: 19/073,774

(22) Filed: Mar. 7, 2025

(51) Int. Cl. H04N 21/2343; A63F 13/5252; A63F 13/86; H04N 21/218; H04N 21/262; H04N 21/845; H04N 21/858

(52) U.S. Cl. CPC H04N 21/2343; A63F 13/5252; H04N 21/21805; H04N 21/262; H04N 21/8456; H04N 21/8586; A63F 13/86

(57) ABSTRACT

Systems and methods provide for mitigating the likelihood of ocular discomfort caused by presentation of media content. A game server initiates a gameplay session for a user device with a plurality of respective video feeds for each of a plurality of respective virtual cameras.

The game server may execute the game logic and forward video streams to the user device which is dynamically altered by user device inputs controlling the game. The game server may then calculate respective virtual inertial measurement unit (IMU) parameters for each of the plurality of respective video feeds. The game server may generate a first stream of the gameplay session by multiplexing: (a) a bitstream of a video feed of a first virtual camera and (b) the calculated respective IMU parameters of the plurality of video feeds and then transmit this multiplexed first stream to the gaming user device.

### BACKGROUND

This disclosure is related to systems and methods for mitigating ocular discomfort in presentation of media content.

### SUMMARY

Live streaming systems via mobile devices and other devices have become increasingly prevalent, with software systems such as Twitch® and other video streaming platforms that enable users to share experiences in participating (e.g., engaging in a gameplay session) and/or spectating (e.g., spectating a videogame session) in real time through video with a shared community that is also spectating. Despite the convenience and ubiquity of such systems, such systems often provide video and media that cause participants to suffer from motion sickness (e.g., induced by excessive motion in the video feeds). Videos that induce such motion sickness can be generated by the system, for example, when a gaming device from which a video originates (e.g., a player moves too quickly in a first-person shooter video game with a lot of acceleration along different vectors or erratically, resulting in a video feed that appears shaky or disorienting.) This issue is particularly problematic for systems that have users who are sensitive to visual motion and can significantly detract from the live streaming experience. It is also noted that this problem exists not only for the spectators, but also for the players or creators themselves who are creating the media content (e.g., playing a cloud service game that is also streamed to spectators). Using the example above, if the player's control inputs move their game character or camera view of their game session too erratically, they may suffer from ocular discomfort.

In one approach, systems may enhance hardware and software capabilities by, for example, improving camera stabilization and screen refresh rates to mitigate distorted video. Such image stabilization features in mobile devices aim to reduce shakiness, but these do not address the specific needs of users or spectators of the system who are sensitive to motion. Moreover, this approach does not allow the system to cater to the subjective nature of motion sickness sensitivity, which varies widely among individuals.

In some implementations, the system (e.g., a system for cloud gaming and/or a system for game streaming) allows devices of participants and viewers who experience motion sickness to rely receive manual user-interface adjustments (e.g., by the streamer), which can only be accomplished by explicit user-interface input provided by the gaming user or spectator informing the streamer (e.g., by voice, comments, or text messages) that they are experiencing motion sickness which is neither efficient nor reliable. The absence of personalized solutions that can dynamically adapt to the gaming user's/spectator's specific needs and thresholds highlights a significant gap in live streaming systems. Consequently, there is a need for an approach that allows for real-time adjustments or switching based on gaming user and spectator-specific sensitivity to motion, thereby providing a more comfortable and inclusive live streaming system for all participants.

To solve these problems, systems and methods are provided herein for providing media content adjustments that mitigate video that is likely to cause motion ocular discomfort (e.g., in live streaming media, in cloud gaming sessions and in spectating gameplay sessions). In some embodiments, a game server initiates a gameplay session for a gaming user device with a plurality of respective video feeds for each of a plurality of respective virtual cameras. For example, a game server initiates a Call of Duty® cloud gameplay session for a gaming user device (e.g., a PC or gaming console) where the game engine provides (or is capable of providing) a first-person view, third-person view, and an overhead view for the game session (e.g., for movement of an avatars in a 3D model of a virtual level). In one approach, the game server executes the game logic (e.g., Call of Duty gaming session) and forwards video streams to the user device (e.g., Sony Playstation®) which is dynamically altered by user device inputs controlling the game character (e.g., the player using a controller to move the character in the gaming environment that alters the visual perspective of the video feed as the character turns right that correspondingly pans the gaming environment right). In this case, the client device acts as a thin client providing inputs to the game server, and displaying a resulting video feed. The game server may then calculate respective virtual inertial measurement unit (IMU) parameters for each of the plurality of respective video feeds (e.g., by analysis of visual characteristics of frames produced by each of the in-game virtual cameras). The IMU parameters may be calculated based on virtual camera frames for each of the respective virtual cameras within the gaming session. Continuing with the above example, the game server calculates the IMU values for the first-person video feed that include, e.g., one or more of angular velocity, object acceleration, orientation, any other suitable parameter, or any combination thereof. The game server may generate a first stream of the gameplay session by multiplexing: (a) a bitstream of a video feed of a first virtual camera and (b) the calculated respective IMU parameters of the plurality of video feeds. Continuing with the above example, the game server may multiplex the first-person video feed with the IMU parameters for all views (e.g., first-person, third-person, and overhead). The game server may then transmit this multiplexed first stream to the gaming user device. Continuing with the above example, the game server transmits this multiplexed stream to the user device for the Call of Duty gaming session.

In some approaches, the provided parameters (e.g., parameters that are multiplexed into the stream) may be used (e.g., by the gaming user device) to determine that the stream is unsatisfactory (e.g., based on stored calibration parameters at the user device). The game server may then (e.g., after a request to switch cameras by the gaming user device) generate a second stream for the gameplay session by multiplexing: (a) a bitstream of a video feed of a second virtual camera and (b) the calculated respective IMU parameters for the plurality of video feeds. In some embodiments, the second virtual camera is selected based on a determination that the IMU parameters of the first virtual camera are not satisfactory (e.g., by the gaming user device). The non-satisfaction determination may be based on IMU calibration data associated with the gaming user device and the IMU parameters for each of the plurality of video feeds (e.g., based on explicit calibration, such as data gathered by showing increasingly shaky/fast clips, or implicit calibration data gathered over time based on reaction to regularly consumed content). Moreover, the non-satisfaction may be determined on a specific threshold being exceeded and/or a sustained threshold being exceeded for a sustained period of time. The game server may then transmit the second stream to the user device for the gameplay session. Continuing with the above example, the game server may generate a second stream using the third-person video feed, as the first-person video feed IMU parameters exceed a sensitivity setting (e.g., angular acceleration exceeding 6.1 m/s² ) for the user using the gaming user device based on the user's calibration data (e.g., when the first person view is ranked as most preferred, and the third-person view was ranked second in preference). In this example, the game server selects the third-person video feed for the Call of Duty gaming session as the IMU parameters for the third-person video feed do not exceed 6.1 m/s². This second stream having the third-person video feed is sent to the user device to switch the virtual camera from first-person to third-person to prevent ocular discomfort for the user of the gaming user device. By multiplexing a plurality of IMU parameters associated with a plurality of video feeds, the present system may select an optimal camera video feed for transmission to mitigate ocular discomfort. In some embodiments, the gaming server may maintain the current video feed based on a characterization of the video segment. For example, if the video segment is a cut-scene in Call of Duty, the gaming server may maintain the current video feed and not generate a second stream using a different video feed.

In some embodiments, a user device (e.g., a different device than the gaming user device that used to play the game) may be configured to spectate a live-event or a video gaming session (e.g., the session of the gaming user device). Similar to the example above, a user device (e.g., a smart television) may spectate and receive a stream of a gameplay session via a streaming server (e.g., Twitch® server) or a combination cloud gaming/streaming systems. The streaming server may receive, from a content delivery system (e.g., a game server described in the example above), a plurality of respective video feeds having respective cameras associated with a content item (e.g., a gaming session of Call of Duty having first-person, third-person, and overhead video feeds). In some embodiments, the streaming server may subscribe to a subset of available video feeds of the respective cameras (e.g., the streaming server may subscribe to only first-person and third-person cameras). In some embodiments, gaming and spectating services may be run on the same server or a same group of servers. In some embodiments, gaming and spectating services may be provided by distinct servers or groups of servers linked by a network. The streaming server may encode each respective video feed in separate segments, where each segment is encoded in multiple quality levels (e.g., bitrate/resolutions). Continuing with the example, the video feeds for first-person, third-person, and overhead view may be encoded in various resolutions and qualities (e.g., 360p, 720p, and 4K, etc.). The streaming server may access respective IMU parameters for the segments and generate a manifest file (e.g., a manifest for HTTP Live Streaming (HLS) or Dynamic Adaptive Streaming over HTTP (MPEG-DASH) or similar adaptive bitrate (ABR) streaming protocols). The manifest file may include addresses or address information (e.g., partial addresses) of the video segments for each video feed and respective IMU parameters for each video feed. The streaming server may transmit the manifest file to the user device (e.g., smart television, laptop, mobile device, etc.) to consume the content item. The user device may use the manifest to stream the game sessions (or other multi-camera content) by accessing the video segments based on network conditions to select video quality, and by using IMU parameters listed in the manifest to select camera angles or virtual cameras that are satisfactory based on comparison of the IMU values in the manifest to IMU calibration data (e.g., that is stored on the user device). Continuing with the example above, the smart television may play segment 1 using first-person view at 720p given a network with particular conditions, but play segment 2 using third-person view at 4K given a change in network conditions at the time segment 2 is scheduled to play. Moreover, each of segments 1 and 2 are accessed as the IMU parameters of the segments are satisfactory when compared to the calibration data of the user device to not cause any ocular discomfort. In this example, while IMU data of segment 2 in first-person view may be unsatisfactory, a selection of third-person view for segment 2 is selected as satisfactory based on IMU data of segment 2 in third-person view.

By accessing segments from the manifest based on IMU satisfaction and video quality, the system may apply a customized level of visual modification (e.g., switching video feeds and/or video quality) based on the tailored calibration data corresponding to ocular discomfort of the user in relation to motion sickness—even in varied network conditions. The present system is not reliant on enhanced hardware or reliant solely on manual adjustments at the video streamer device to accommodate one or more users participating in the video stream. Instead, the spectator may receive automated switching of video feeds without manual real-time adjustments on the user device. Moreover, the present system provides switching of video feeds to mitigate motion sickness for a variety of video applications including spectating gameplay sessions, live events, and other video applications.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario in which a first bitstream video feed is transferred from a game server to a user device, in accordance with some embodiments of this disclosure.

FIG. 1B shows an illustrative scenario in which the user device transmits a request for selection of a different video feed of the gameplay session, in accordance with some embodiments of this disclosure.

FIG. 1C shows an illustrative scenario in which a second bitstream video feed is transferred from the game server to the user device, in accordance with some embodiments of this disclosure.

FIG. 2A shows an illustrative scenario in which a streaming server receives video feeds from cameras associated with a gameplay session, in accordance with some embodiments of this disclosure.

FIG. 2B shows an illustrative scenario in which a streaming server encodes a bitstream and generates a manifest, in accordance with some embodiments of this disclosure.

FIG. 2C shows an illustrative scenario in which a user device accesses video segments from the manifest based on network conditions and satisfactory IMU parameters, in accordance with some embodiments of this disclosure.

FIG. 3 shows an illustrative example of a cloud gaming architecture providing a plurality of video feeds for a gaming session, in accordance with some embodiments of this disclosure.

FIG. 4 shows a flow chart of a cloud gaming engine providing multi-camera view with IMU for a spectator device, in accordance with some embodiments of this disclosure.

FIG. 5 shows a flow chart of a cloud gaming engine providing multi-camera view with IMU for a gaming device, in accordance with some embodiments of this disclosure.

FIG. 6 shows an illustrative example of a cloud gaming architecture providing a plurality of video feeds for a gaming session including an ABR transcoder, in accordance with some embodiments of this disclosure.

FIG. 7 shows a flow chart of ABR generation, in accordance with some embodiments of this disclosure.

FIG. 8 shows an illustrative example of a user device saving sickness thresholds, in accordance with some embodiments of this disclosure.

FIG. 9 shows an illustrative example of an ABR system adjusting segment selection based on a saved game clip gravity-inertial acceleration threshold values, in accordance with some embodiments of this disclosure.

FIG. 10 shows a flow chart of spectator camera switching based on the user selection of cameras, in accordance with some embodiments of this disclosure.

FIG. 11 shows a flow chart of a player requesting a new camera view, in accordance with some embodiments of this disclosure.

FIG. 12 shows an illustrative example of a cloud game application camera switching, in accordance with some embodiments of this disclosure.

FIG. 13 shows an illustrative example of a temporal diagram for detection of a selection to switch cameras, in accordance with some embodiments of this disclosure.

FIG. 14 shows a flow chart of a player selection to switch cameras, in accordance with some embodiments of this disclosure.

FIG. 15 shows an illustrative example of a local video game console gaming system on a local area network, in accordance with some embodiments of this disclosure.

FIG. 16 shows a flow chart of camera selection based on the player's requested camera view and a calculated sickness threshold, in accordance with some embodiments of this disclosure.

FIG. 17 shows a flow chart of a local device performing camera selection based on a spectator's requested camera view and a calculated sickness threshold, in accordance with some embodiments of this disclosure.

FIG. 18 shows an illustrative example of a user device running an application for spectating connected to a local area network, in accordance with some embodiments of this disclosure.

FIG. 19 shows a flowchart of a spectator's application running on a user device on the same local area network as a gaming device offering a spectator service, in accordance with some embodiments of this disclosure.

FIG. 20 shows a flowchart of a request for a new camera view from the spectator service, in accordance with some embodiments of this disclosure.

FIG. 21 shows a sequence diagram of a user device playing a game while outputting the gameplay session to a spectating platform, in accordance with some embodiments of this disclosure.

FIG. 22 shows a sequence diagram of an algorithmic delay that is applied on each spectator's device to reduce motion sickness without altering the main video stream, in accordance with some embodiments of this disclosure.

FIG. 23 shows a sequence diagram of synchronized viewing from multiple perspectives for spectators watching the same game session, in accordance with some embodiments of this disclosure.

FIG. 24 shows a sequence diagram for automatic camera angle selection, in accordance with some embodiments of this disclosure.

FIG. 25 shows a sequence diagram for spectator discomfort detection or signs of motion sickness using real-time biometric data, in accordance with some embodiments of this disclosure.

FIG. 26 shows illustrative user equipment devices, in accordance with some embodiments of this disclosure.

FIG. 27 shows illustrative systems, in accordance with some embodiments of this disclosure.

FIG. 28 is a flowchart of a detailed illustrative process for generating a second stream for the gameplay session, in accordance with some embodiments of this disclosure.

FIG. 29 is a flowchart of a detailed illustrative process for accessing selected video segments from the respective addresses in a manifest, in accordance with some embodiments of this disclosure.

### DETAILED DESCRIPTION

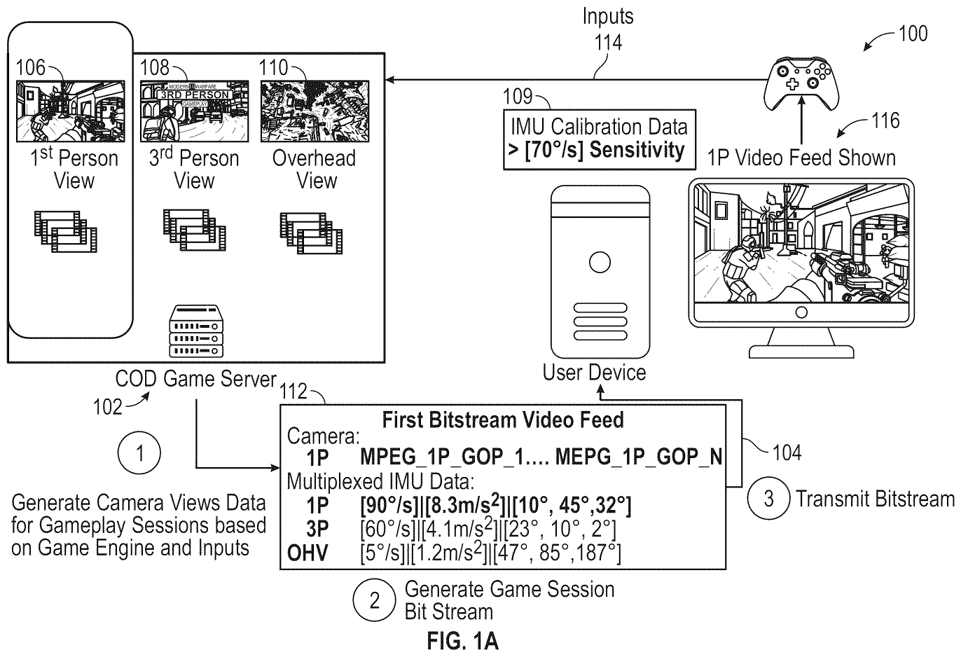

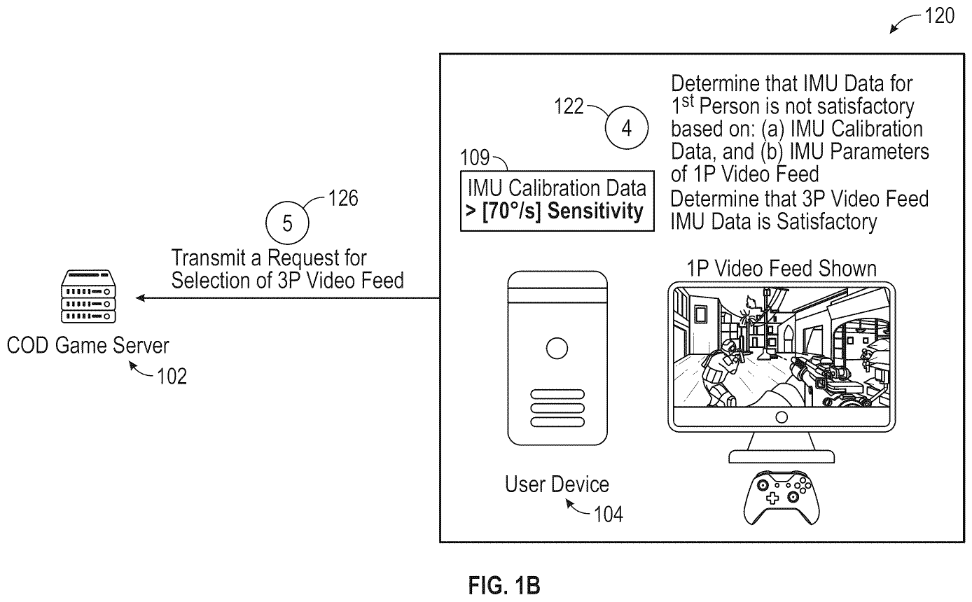

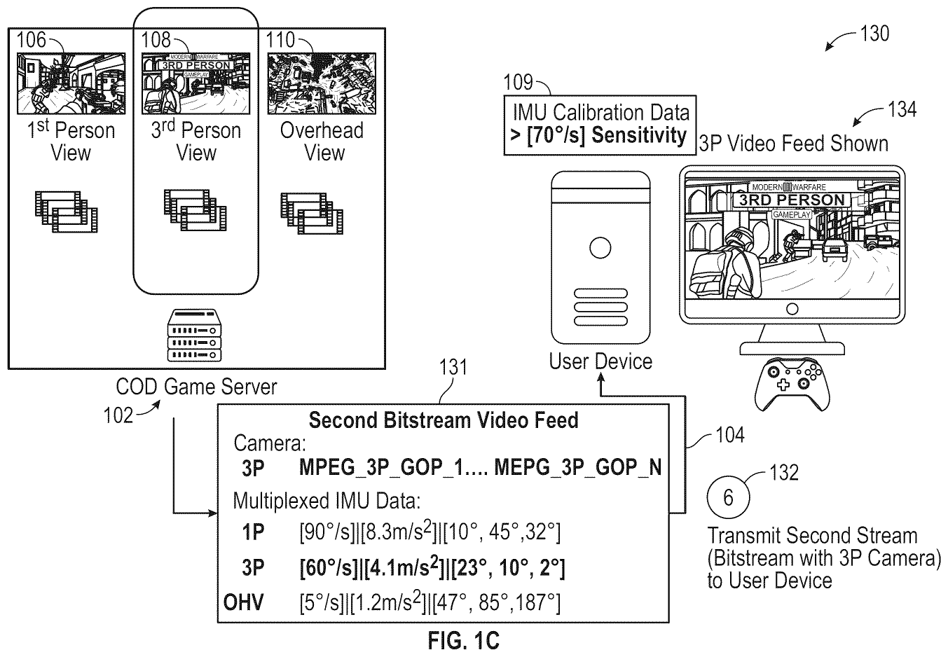

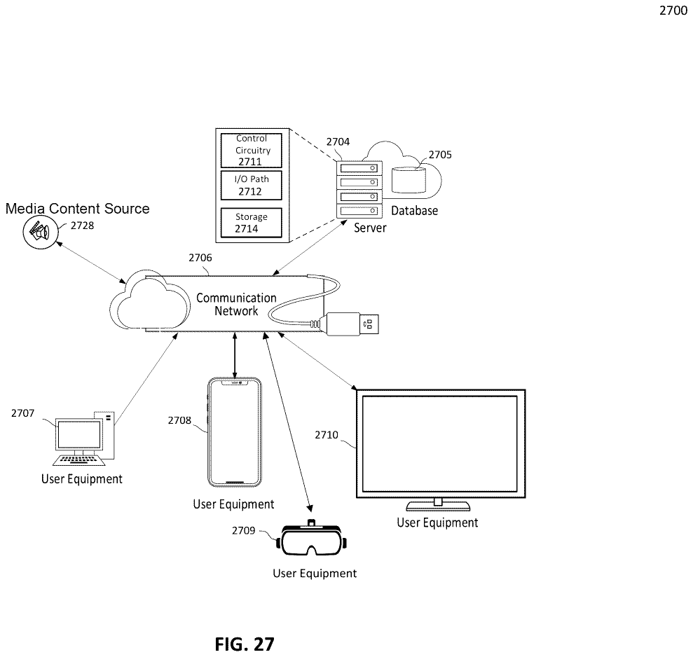

FIG. 1A shows an illustrative scenario 100 in which a first bitstream video feed is transferred from a game server to a user device, in accordance with some embodiments of this disclosure. The game server may be any suitable device (e.g., one or more servers) that has processing capability and connectivity to a communications network (e.g., similar to FIG. 27 with communication network 2706) that facilitates the implementation of gameplay sessions to one or more user devices. The user device may be any suitable device (e.g., personal computer, smartphone, gaming console, smart television, etc.) that has processing capability and connectivity to a communications network that facilitates the implementation of gameplay sessions for one or more users (e.g., similar to FIG. 27 with user equipment 2707, 2708, 2709, and 2710). In some embodiments, the game server may execute a gaming application that facilitates the function (e.g., systems and methods) of the game server. The game server may initiate a gameplay session for a user device. The game server may receive input from a user input interface (e.g., a game controller and/or mouse and keyboard connected to a user device) to allow for a gameplay experience in 3D rendered model of a game world. This may generate a plurality of rendered frames from one or more virtual game cameras (e.g., first-person view, third-person view, etc.) For example, in FIG. 1A, the COD game server 102, initiates a gameplay session for the game Call of Duty (COD). The game server may generate a plurality of respective video feeds for each of a plurality of respective virtual cameras for the gameplay session. Continuing with the above example, COD game server 102 generates a first-person virtual camera video feed 106, a third-person video feed 108, and an overhead video feed 110.

In some embodiments, the virtual cameras may include one or more vantage points of the gameplay session (e.g., first-person perspective, third-person perspective, chase camera perspective, free-roam perspective, fixed-camera angle perspective, isometric perspective, or top-down perspective).

The game server may calculate respective virtual inertial measurement unit (IMU) parameters for each of the plurality of respective video feeds. The IMU parameters are received via a virtual IMU sensor that may include data for linear acceleration, angular velocity, and potentially orientation from an object within the gaming session. In some embodiments, the game server may calculate the respective virtual IMU parameters (e.g., linear acceleration, angular velocity, and/or spatial orientation) based on rendered frames for each of the plurality of respective video feeds. For example, rendered frames may include a number of frames between two timestamps of the COD gameplay session. The game server may generate a first stream associated with the gameplay session by multiplexing: (a) a bitstream of a video feed of a first virtual camera of the plurality of respective virtual cameras, and (b) the calculated respective IMU parameters for each of the plurality of video feeds of the plurality of respective virtual cameras. Continuing with the above example, the COD game server 102 generates the first bitstream video feed 112 by multiplexing (a) the first-person video feed 106 (e.g., the video feed may be identified as MPEG_1P_GOP_1 to MPEG 1P_GOP_n.) and (b) IMU parameters for the first-person camera IMU parameters, the third-person camera IMU parameters, and the first-person camera IMU parameters. The game server may then transmit the first stream to the user device. Continuing with the above example, the COD game server 102 transmits the generated first bitstream video feed 112 to the user device 104 to display the first-person video feed 116.

In some embodiments, the user device may provide instruction to the game server 102 via a user interface. In this embodiment, the instruction to the UI may be provided via input of the user device 114 (e.g., game controller, keyboard, mouse, voice, or any other input control for the user device).

In some embodiments, the game engine may generate IMU data leveraging a dedicated middleware (e.g., Nvidia's PhysX middleware). The middleware may offer an object's acceleration, angular velocity, and sometimes even magnetic field information providing a more realistic and dynamic camera perspective in a simulated environment. For example, the camera may receive data like linear acceleration, angular velocity, and potentially orientation from a simulated IMU sensor attached to the object the camera is tracking. The IMU data may include dynamic camera movement based on the IMU data. The camera may adjust its position, rotation, and tilt in real-time to mimic the movement of the object in the simulation, creating a more immersive experience. A simulation environment may be used to simulate the movement and interactions of objects within a scene where an IMU sensor is added to the simulated object, providing real-time data on its motion. The camera system within the simulation may use the IMU data to update its position and orientation, essentially following the object's movement. An example of the simulation environment may be a NVIDIA Isaac Sim platform that allows for easy integration of IMU sensors and provides features to create a camera with dynamic IMU-based movement. In some embodiments, the game server may calculate, from the IMU data, the gravitational inertial acceleration during dynamic motion. A complementary filter or Kalman filter may be implemented utilizing sensor fusion techniques that combine accelerometer, gyroscope, and sometimes magnetometer data to estimate orientation and filter out gravity.

Upon calculation of the device orientation, a rotation matrix may be applied to transform the acceleration data to the global frame, effectively separating gravity. For example, if IMU reading in the device frame provides ax, ay, az IMU acceleration components, then applying rotational matrices based on orientation angles (pitch, roll, yaw) derived from gyroscope data may transform the IMU data to a global frame, isolating gravity.

FIG. 1B shows an illustrative scenario 120 in which the user device transmits a request for selection of a different video feed of the gameplay session, in accordance with some embodiments of this disclosure. The personal computer user device 104 determines, at 122, that the IMU calibration data 109 (e.g., angular velocity must not exceed 70 degrees per second) is not satisfactory relative to the first-person video feed (e.g., first person video feed has IMU parameters of angular velocity having a value of 90 degrees per second). The user device 104 then transmits a request to the game server 102 for selection of the second virtual camera (e.g., third-person video feed 126). In some embodiments, the determination that the IMU data is not satisfactory relative to the video feed may include a plurality of calculations. For example, the game server and/or user device may determine that the angular velocity may not exceed a value and that it may not exceed it for a specific time period (e.g., angular velocity must not exceed 70 degrees per second for 3.3 seconds). Various other sub-conditions may be applied to determine the condition non-satisfaction. In some embodiments, the user device may determine the condition of non-satisfaction, and this information may be transmitted from the user device to the game server. In this scenario, the game server, based on the received condition of non-satisfaction, may generate a second stream for the gameplay session. The game server may generate a second stream for the gameplay session by multiplexing: (a) a bitstream of a video feed of a second virtual camera of the plurality of respective virtual cameras, and (b) the calculated respective IMU parameters for each of the plurality of video feeds of the plurality of respective virtual cameras. The second virtual camera may be a different camera than the first virtual camera (e.g., a third-person video feed compared to a first-person video feed). The second virtual camera is selected for the second stream based at least in part on determining that IMU parameters of the first virtual camera are not satisfactory based on: (a) IMU calibration data associated with the user device, and (b) the IMU parameters for each of the plurality of video feeds. In some embodiments, the determining that IMU parameters of the first virtual camera are not satisfactory based on: (a) IMU calibration data associated with the user device, and (b) the IMU parameters for each of the plurality of video feeds, which may be determined by the user device. In some embodiments, the gaming server may maintain the current video feed based on a characterization of the video segment. For example, if the video segment is a cut-scene in Call of Duty, the gaming server may maintain the current video feed and not generate a second stream using a different video feed. In other embodiments, the characterization of the video segment may include in-game advertising that may also maintain the current video feed and not generate a second stream using a different video feed. The characterization of the video segments that negate the gaming server from generating second stream may be preprogrammed (e.g., via metadata) within the media content that is accessed by the game server.

In some embodiments, the user device may implement a sensitivity calibration to determine sensitivity for a plurality of motion types. These motion types may be generated for display via a calibration video via a user interface that also generates for display a sensitivity scale of discomfort. The user device may receive feedback data based on the calibration video. For example, the user device may receive a neutral emoji selection, via selection from the user interface for a leftward motion type, whereas the user device may receive a dizzy emoji for a shaking motion type. FIG. 1C shows an illustrative scenario 130 in which a second bitstream video feed is transferred from the game server to the user device, in accordance with some embodiments of this disclosure. The COD game server 102 generates a second video feed 131 for the gameplay session by multiplexing the third-person video feed (e.g., MPEG_3P_GOP_1 . . . MEPG_3P_GOP_n) with IMU data from all video feeds. The game server may transmit the second stream to the user device for the gameplay session. Continuing with the above example, the COD game server 102 transmits, at 132, the second bitstream video feed 131 to the user device 104 displaying the third-person video feed 134.

In some embodiments, the game server determines the IMU calibration data associated with the user device by generating for display, through a user interface, a plurality of sensitivity options for selection comprising selections from desirable to undesirable. The UI may provide a number of emojis generated for display to the user device that start from very happy, to happy, to neutral, to sad, to dizzy. This is intended to be a progressive scale of comfort with neutral in the middle and two settings of comfort or very comfortable and conversely uncomfortable and very uncomfortable. The user device may then receive a user interface input from the user device (e.g., similar to FIG. 1A, where user device 104 receives UI input from controller 114) indicating a selected sensitivity option from the plurality of sensitivity options. For example, if the user device server may receive a dizzy emoji for the shaking motion type, the user device may select a sensitivity setting associated with the visual characteristic that caused dizziness. The sensitivity setting may be a mathematical expression, confidence value, mean, average, or other computable means that represent the sensitivity of the user based on the received feedback. This sensitivity setting may be transmitted from the user device to the game server. In some embodiments, the IMU calibration data association may be performed by at least one of the game server and/or the user device.

In some embodiments, the game server and/or user device may determine that the IMU parameters of the first virtual camera are not satisfactory by determining at least one sensitivity setting for the user device. The one sensitivity setting for the user device indicates visual characteristics that are indicated as not satisfactory. For example, in FIG. 1A at 109, it is determined that angular velocity of an object exceeding 70 degrees per second is not satisfactory. The game server and/or user device may then determine that the IMU parameters of the first virtual camera match the at least one sensitivity setting for the user device. Continuing with the example, in FIG. 1A at 112, the IMU data for the first virtual camera, the first-person video feed, has an angular velocity of 90 degrees per second that exceeds the user's sensitivity setting of 70 degrees per second. In some embodiments, the game server and/or the user device may generate display of a calibration video. The calibration video may include depictions of a plurality of motion types (e.g., horizontal, vertical, rotational, jittery, shaky, blurry, rapid, slow, smooth, etc.). The game server and/or the user device may receive biometric data while generating for display the calibration video. For example, during the display of a jittery video, the user device may receive data from a smartwatch that provides heartrate and perspiration metrics associated with the same timestamps as the jittery video. The game server and/or the user device may determine the at least one sensitivity setting for the user device based on at least the received biometric data exceeding a sensitivity threshold. Continuing with the example, if the user's heart rate was varied within five beats per minute for the duration of the gaming session prior to the jittery movements, and then the user's heart rate increased by 20 beats per minute upon display of the jittery movements, then this may exceed a predefined threshold of comfort for the user. In some embodiments, exceeding the predefined threshold may be a singular determination and/or may be a determination that must exceed the predefined threshold for a temporal limit for a sustained period of time and/or exceeds the threshold a number of times within a temporal limit.

In some embodiments, the game server may select the second virtual camera for the second stream based on (a) determining that IMU parameters of the first camera do not match the at least one sensitivity setting for the user device, and (b) a predetermined preference ranking for the plurality of respective virtual cameras. For example, the user may predefine their preference of cameras having the following priority ranking from most desirable to least desirable: first-person view, third-person view, and overhead view. In some embodiments, the game server may select the second virtual camera for the second stream based on determining that the respective IMU parameters do not match the at least one sensitivity setting for the user device, and selecting the second virtual camera associated with the respective IMU parameters. For example, in FIG. 1A at 109, it is determined that angular velocity of an object exceeding 70 degrees per second is not satisfactory. The IMU data for the first virtual camera, the first-person video feed, has an angular velocity of 90 degrees per second which exceeds the user's sensitivity setting of 70 degrees per second. Thus, the game server may determine the second virtual camera as the third-person video feed, as the third-person video feed has an angular velocity that is 60 degrees per second. The third-person video feed satisfies the sensitivity setting of the user, as the object does not exceed 70 degrees per second. In some embodiments, the game server selects the second virtual camera for the second stream by implementing a preassigned priority for selection by the cloud gaming system. For example, the COD game server 102 may preassign the third-person video feed a higher priority than the overhead video feed. Thus, if the first-person video feed is determined as not satisfactory, the second virtual camera would be the third-person video feed rather than the overhead video feed.

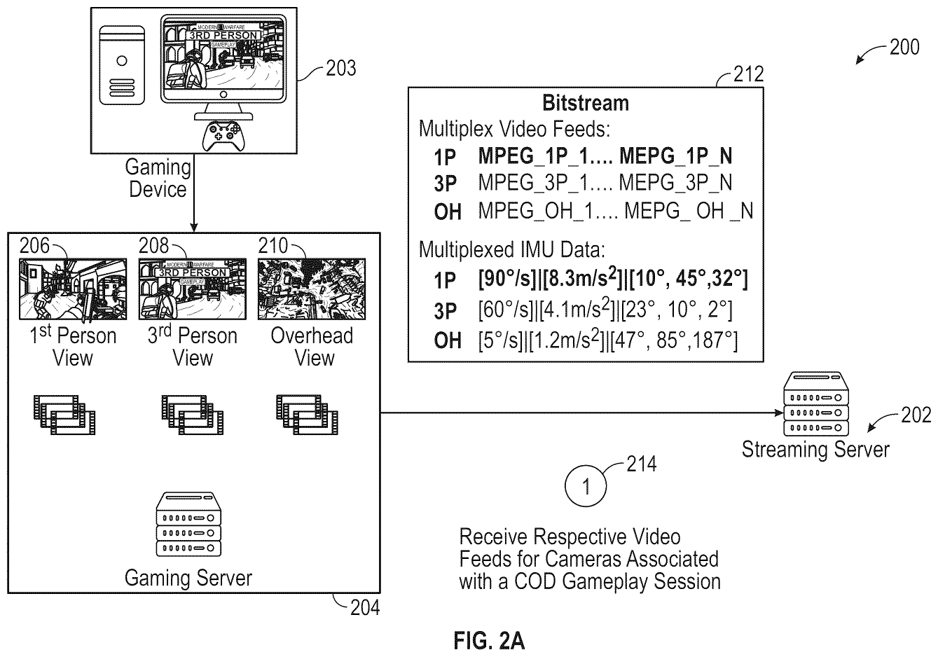

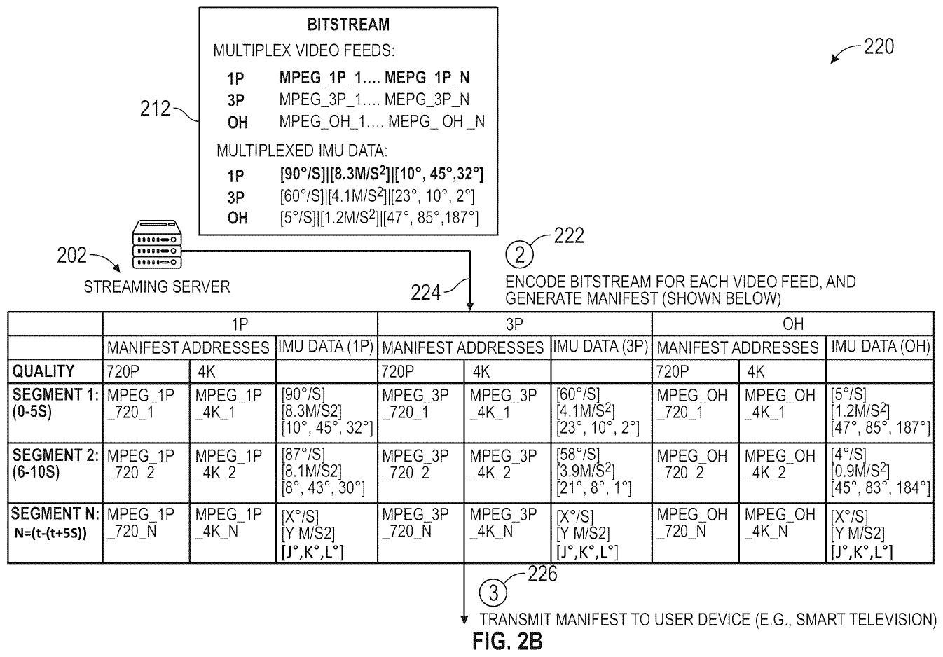

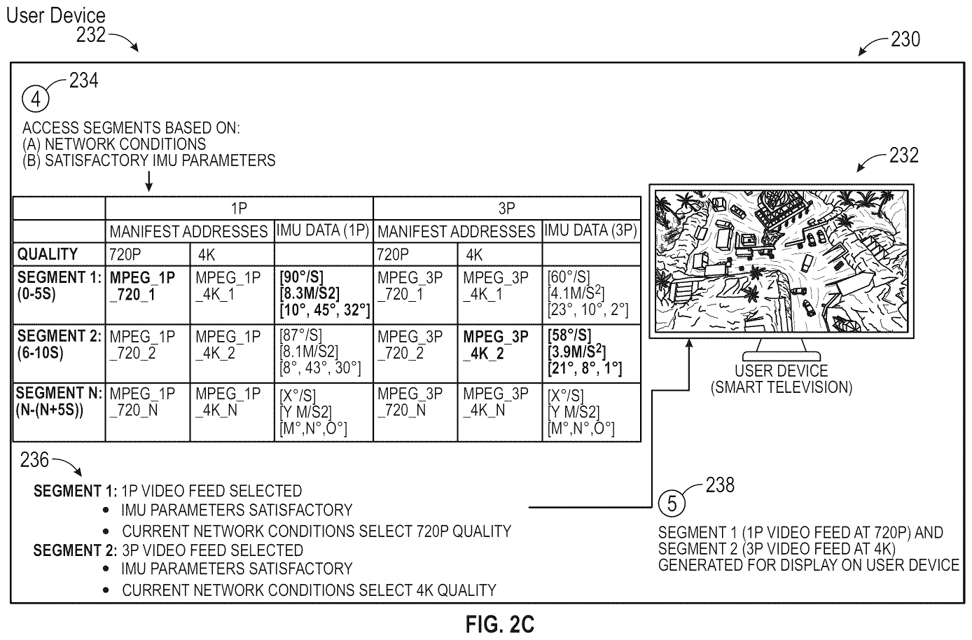

In some embodiments, a streaming server may receive from a content delivery system (e.g., a game server, a media server, etc.) a plurality of respective video feeds for each of a plurality of respective cameras associated with a content item. The streaming server may be any suitable device (e.g., one or more servers) that has processing capability and connectivity to a communications network that facilitates the streaming of media content (e.g., gameplay sessions, live events) to one or more user devices. In some embodiments, the streaming server may execute a streaming application that facilitates the function (e.g., systems and methods) of the streaming server. FIG. 2A shows an illustrative scenario 200 in which a streaming server receives video feeds from cameras associated with a gameplay session, in accordance with some embodiments of this disclosure. The gameplay session may be of the gaming device 203, and respective cameras include virtual cameras of vantage points of the gameplay session. The streaming server 204 receives, at 214, video feeds 206, 208, and 210 from the game server 204 for the game Call of Duty (COD). The video feeds correspond to a first-person video feeds 206, a third-person video feed 208, and an overhead video feed 210 for the gaming session. Gaming device 203 may be the user device 104 in FIGS. 1A-C, where the gaming device 203 is running a COD gaming session (that would be the same as the COD gaming session running on user device 104). In some embodiments, the streaming server may share the same hardware as the game server. For example, the game server in FIG. 1A at 102 may be able to utilize the same hardware as the streaming server in FIG. 2A at 202. In some embodiments, the video feeds of the gameplay session may correspond to virtual cameras including first-person perspective, third-person perspective, chase camera perspective, free-roam perspective, fixed-camera angle perspective, isometric perspective, or top-down perspective. The streaming server 204 may receive the video feeds via a bitstream 212 that includes the multiplexed video feeds and multiplexed IMU data for each of the respective video feeds. In some embodiments, the content item includes a stream of a live event (e.g., live sporting event, live concert, reality television, live game-show, or similar type of live media content). The plurality of respective cameras includes a plurality of physical cameras capturing the live event from multiple physical locations (e.g., an overhead stadium view, a zoom view, a chase camera view, a ground level camera view, a low angle camera view, a high angle camera view, and similar types of views). In some embodiments, the streaming server may subscribe to a subset of the plurality of respective cameras such that the streaming server only receives the cameras to which it subscribes. For example, the streaming server may only subscribe to a first-person and third-person video feeds of the plurality of respective cameras and not subscribe to the overhead video feed.

For each respective video feed, the streaming server may encode the respective video feed as a respective set of a plurality of video segments. Each respective set is encoded at one or more of respective quality levels of a plurality of quality levels. Quality levels may include any combination of a plurality of bitrates, plurality of resolutions, plurality of frame rates, plurality of compressions depths, plurality of color depths, plurality of bit-depths, plurality of chroma sampling, plurality of aspect ratios, or plurality of codecs, or any suitable combination of the above. The streaming server may then access calculated IMU parameters for the respective set of the plurality of video segments. FIG. 2B shows an illustrative scenario 220 in which a streaming server 202 transcodes a bitstream and generates a manifest, in accordance with some embodiments of this disclosure. At 222, the streaming server 202 transcodes the plurality of encoded video feeds from the bitstream 212 for each encoded video feed to generate a manifest 224. In some embodiments, the streaming server may utilize a separate encoding module for the encoding of the plurality of the encoded video feeds. In some embodiments, the encoding modules may be connected via a communications network (e.g., a cloud-based encoding module). In some embodiments, the encoding may utilize the HLS standard. The streaming server may implement HLS by compressing the raw video, segmenting it into video segments, and creating multiple versions at different quality levels. During playback, the user device may request the appropriate segments based on available bandwidth, ensuring smooth streaming without buffering. In some embodiments, the encoding may utilize MPEG-DASH by dividing the raw video into video segments and encoding them at multiple quality levels. During playback, the user device requests segments based on current network conditions, ensuring smooth streaming by adjusting the quality in real-time.

The streaming server may generate and update a manifest file that includes respective addresses of each respective set of plurality of video segments for each respective video feed and the respective IMU parameters for each respective plurality of video segments for each respective video feed. As shown in FIG. 2B, the streaming server 202 generates the manifest 224 that has addresses for each video segment. For example, the address for the video segment that is encoded in 720p for segment 1 in the first-person video feed is MPEG_1P_720_1. The corresponding IMU data for this segment include [90°/s], [8.3 m/s2], [10°, 45°, 32°], and any other suitable IMU data. There may be a plurality of segments denoted as segment ‘n’ having respective manifest addresses and corresponding to a particular timestamp (e.g., t to t plus five seconds and/or any segment length in different embodiments). In some embodiments, the IMU data may be received from the streaming server. In other embodiments, the IMU data may be received from the user device. In some embodiments, the IMU data may be virtual IMU data based on simulation of motion in a three-dimensional space (e.g., virtual cameras). In some embodiments, the IMU data may be based on physical cameras moving in a three-dimensional space. As seen in FIG. 2, each respective video feed (e.g., from each virtual camera) has its own adaptation set (e.g., the adaption set having different segments encoded at different video qualities), wherein each adaptation set includes its own respective IMU parameters.

Additionally, each segment has its own address or partial addressed data that may be merged with a server address to create a full address (e.g., segment 1 at 720p has associated partial address MPEG 1P_720_1). The entire manifest 224 may have its own address (e.g., from which it can be retrieved) that includes information for all adaptation sets of every virtual camera.

The streaming server may transmit the manifest to a user device to cause the user device to consume the content item by accessing selected video segments from the respective addresses in the manifest. Accessing the selected video segments is based on the user device determining (a) network conditions; and (b) determining of which of the respective IMU parameters for each video segments of the respective plurality of video segments are satisfactory based on IMU calibration data associated with the user device. In FIG. 2B, the streaming server 202 transmits the manifest to the user device (e.g., smart television 232). FIG. 2C shows an illustrative scenario 230 in which a user device accesses video segments from the manifest based on network conditions and satisfactory IMU parameters, in accordance with some embodiments of this disclosure. The smart television user device 232 receives the manifest from the streaming server 202. The smart television user device 232 accesses the video segments for the COD gameplay session that is being spectated by the user of the smart television user device 232. At 234, the accessing of the video segments is based on the network conditions and satisfactory IMU parameters. For example, at 236, segment 1, which includes a first-person video feed, is accessed as the respective IMU parameters are satisfactory and the current network conditions select 720p video quality. Segment 2, which includes a third-person video feed, is accessed as the respective IMU parameters are satisfactory and the current network conditions support 4K video quality. At 238, these accessed video segments are generated for display on the smart television user device 232. In this example, the first-person video feed is given priority as it is the streaming server's first choice based on provider preferences of cameras. In other embodiments, there may not be a priority video feed based on provider preferences, and the video feed selected is based on user device preferences. However, because the IMU parameters would not be satisfactory for segment 2, the user device (e.g., smart television) accesses segment 2 having a third-person video feed. Upon the first-person video feed IMU parameters being satisfied at a later temporal time within the media, the user device may access the upcoming video segment n using the first-person video feed. In some embodiments, the streaming server and/or user device may maintain the current video segment based on a characterization of the video segment. For example, if the video segment is a cut-scene in Call of Duty, the streaming server and/or user device may maintain the video segment and not select an alternative video segment from the manifest using a different video feed. In other embodiments, the characterization of the video segment may include in-game advertising that may also maintain the current video segment. The characterization of the video segments that negate the streaming server and/or user device from selecting a different video segment (with different video feed) may be preprogrammed (e.g., via metadata) within the media content that is accessed by the streaming server and/or user device.

In some embodiments, the determination of which of the respective IMU parameters for each video segments of the respective plurality of video segments are satisfactory based on IMU calibration data associated with the user device may be determined by the streaming server and/or the user device. In some embodiments, the calibration data may be generated as discussed in U.S. patent application Ser. No. 18/943,382 “Systems and Methods for Mitigating Motion Ocular Discomfort in Live Streaming Media,” which is hereby incorporated by reference herein in its entirety. The determination may be based on determining at least one sensitivity setting for the user device, wherein the at least one sensitivity setting for the user device indicates visual characteristics that are indicated as not satisfactory. This may be done as articulated earlier in the description by providing a calibration video to the user device for the user to provide feedback through a user interface to select calibration of ocular discomfort. The streaming server and/or user device may then determine that respective IMU parameters for the selected video segments match the at least one sensitivity setting for the user device. In some embodiments, determining the at least one sensitivity setting includes generating for display a calibration video for the user device. The calibration video may include depictions of a plurality of motion types as mentioned previously. The streaming server and/or user device may then receive biometric data while generating for display the calibration video (e.g., heartrate, perspiration, or similar biometric data from a biometric device such as a smartwatch), and determine the at least one sensitivity setting for the user device based on at least the received biometric data exceeding a sensitivity threshold.

In some embodiments, each respective IMU parameters, calculated by the streaming server, for the respective set of plurality of video segments includes representative IMU parameters for each segment of the respective set of plurality of video segments. For example, if there are 240 frames in a video segment, there may be representative IMU parameters that represent all 240 collectively. In some embodiments, the representative IMU parameters may be calculated by the streaming server, game server and/or user device based on an average value of IMU parameters for a respective segment, a highest value of IMU parameters for the respective segment, or a median value of IMU parameters for the respective segment. In some embodiments, the calculated respective IMU parameters may include linear acceleration, angular velocity, and/or orientation of an object within the content item.

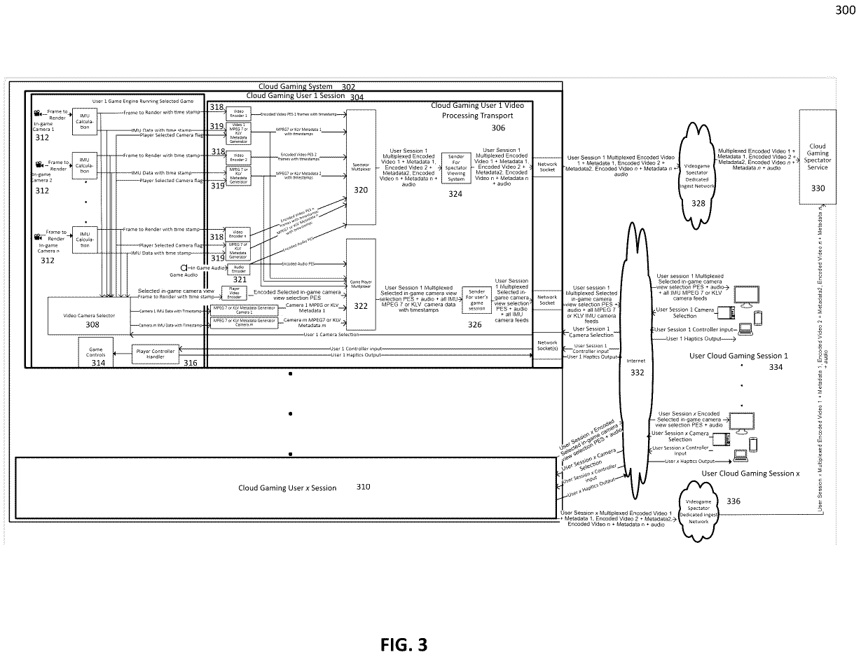

FIG. 3 shows an illustrative example of a cloud gaming architecture 300 providing a plurality of video feeds for a gaming session, in accordance with some embodiments of this disclosure. The game server (e.g., denoted as cloud gaming system 302) may provide dedicated video feeds (e.g., in game cameras 1, 2, and 3 denoted 312) for in-game viewing of a gameplay session (e.g., cloud gaming user 1 session 304) by the player to change their view based on the player's choice of video feeds (e.g., similar to FIGS. 1A-C with multiple video feeds including first-person video feed 106, third-person video feed 108, and overhead video feed 110). Gaming user device 310, utilized by a game player, shown lower in the figure (e.g., similar to game server 102 in FIGS. 1A-C) offers multiple cameras for viewing by a spectator and/or the game player. The user cloud gaming session 334, facilitating the game player, may have a subset of cameras to select from compared to what is presented in the game session 304. The cloud gaming system 302 offers multiple camera video feeds from a game engine running a specific game title (e.g., Call of Duty in FIG. 1A). These video frames are also time stamped with a common system clock time. Along with each video camera feed, there is an associated IMU data feed with each camera that also has a time stamp with a common system clock time. The IMU data feed's clock time will match a video frame's clock time. A cloud gaming user 1 video processing transport 306 facilitates encoding and multiplexing of the frames from the one or more in-game cameras. The frame to render will be sent to a video encoder, at 318, and the associated IMU calculation will be output to an MPEG 7, KLV or SEI Metadata Generator, at 319, for each camera view. The encoded video and generated KLV, MPEG 7 or SEI data will be sent to a multiplexer, 320, and all multiplexed together to be delivered to an external system 324 which is designed for spectator viewing. The multiplexed stream including the video encoding of all available video camera feeds for the player or spectator to choose from along with the associated camera IMU metadata will be distributed one or more external streaming servers (e.g., similar to FIG. 2A, streaming server 202). The video camera selector 308, which selects the camera video feed for the gaming session, may also follow the similar process as outlined above for the spectator camera processing transport, namely where the camera 1 to n with IMU data and metadata with timestamp may be multiplexed via the game player multiplexer 322.

The cloud gaming system 302 may then transport the multiplexed data to the spectator viewing system 324 and/or the game user's game session 326. In the spectator embodiment, the video game spectator dedicated ingest network 328 receives the multiplexed data and provides it to cloud gaming spectator service (e.g., Twitch server) 330. Similarly, the video game spectator dedicated ingest network 336 receives multiplexed data from a cloud gaming user x session 310 and provides it to the cloud gaming spectator service 330 for other gaming sessions (e.g., cloud gaming user x session 310) that are different than cloud gaming user 1 session 304. In the game player embodiment, the multiplexed data is transmitted through the internet 332 and provides it to user cloud gaming session 334 (e.g., personal computer of user engaging in gaming session).

A separate game play multiplexer 322 only multiplexes the selected in-game camera view with the full IMU metadata for all camera along with metadata and timestamps. An audio encoder 321 encodes game audio (e.g., as Audio Engineering Society or AES) and transmits this encoded audio to both the spectator multiplexer 320 and the game player multiplexer 322. In some embodiments, the spectator multiplexer 320 and the game player multiplexer 322 are the same multiplexer. As with video games today, additional video feeds including some or all the spectator's cameras may be made available to the game player for viewing while playing the game. The available video feeds for the video game may be selected manually by the game player or optionally may be selected by the user device (e.g., Sony Play Station).

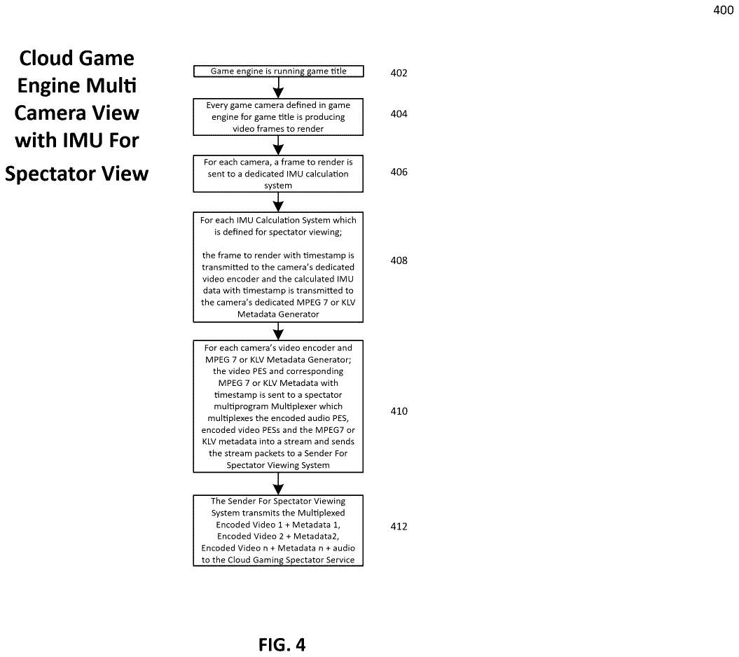

FIG. 4 shows a flow chart 400 of a cloud gaming engine providing multi-camera views with IMU for a spectator device, in accordance with some embodiments of this disclosure. At 402, the cloud gaming engine may run a game title (e.g., similar to FIG. 2A where game server 204 is running COD). At 404, the cloud gaming engine may render video frames for every game camera (e.g., similar to FIG. 2A where the COD game server generates frames to render from video feeds based on first-person view 206, third-person view 208, and overhead view 210 video feeds). At 406, the cloud gaming engine may determine the corresponding IMU for the frames utilizing a dedicated IMU calculation system (e.g., similar to FIG. 2A where the COD server determines, at 212, the IMU values corresponding to the plurality of video feeds). At 408, the cloud gaming engine may, for each IMU calculation system which is defined for spectator viewing, the frame to render with timestamp is transmitted to the corresponding camera's dedicated video encoder. The calculated IMU data with timestamp may then be transmitted to the camera's dedicated MPEG 7 or KLV metadata generator. At 410, the cloud gaming engine may transmit each respective camera's encoded frames and associated metadata generator with timestamp to a spectator multiprogram multiplexer. The multiplexer multiplexes the encoded audio PES and encoded video PES and the MPEG7 or KLV metadata into a bitstream and transmits this bitstream to a sender for a spectator viewing system. At 412, the sender for the spectator viewing system transmits the multiplexed encoded video feeds and metadata and audio to a cloud gaming spectator service (e.g., similar to FIG. 2A streaming server 202).

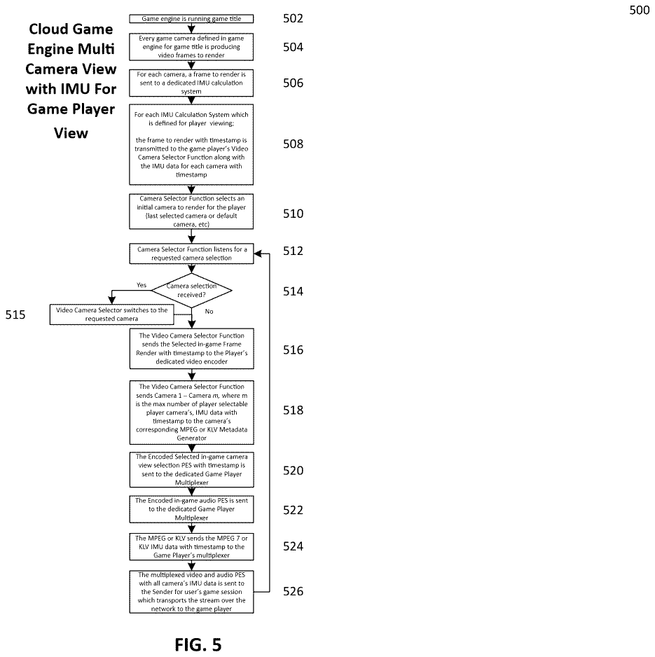

FIG. 5 shows a flow chart 500 of a cloud gaming engine providing multi-camera view with IMU for a gaming device, in accordance with some embodiments of this disclosure. At 502, the cloud gaming engine may run a game title (e.g., similar to FIG. 1A where the COD game server is running COD). At 504, the cloud gaming engine may render video frames for every game camera (e.g., similar to FIG. 1A where the COD game server generates frames to render from video feeds based on first-person view 106, third-person view 108, and overhead view 110 video feeds). At 506, the cloud gaming engine may determine the corresponding IMU for the frames utilizing a dedicated IMU calculation system (e.g., similar to FIG. 1A where the COD server determines the corresponding IMU values at 112 to the plurality of video feeds). At 508, the cloud gaming engine may, for each IMU calculation system which is defined for player viewing, the frame to render with timestamp is transmitted to the player's camera selector function along with IMU data for each camera with timestamp. At 510, the cloud gaming engine may, via the camera selector function, select an initial camera to render for the player (e.g., similar to FIG. 1A where the first-person video feed camera is selected). At 512, the cloud gaming engine may await receipt of a requested camera selection (e.g., via input). At 514, if a camera selection is received, the process proceeds to 515. At 515, the cloud gaming engine, via the camera selector function, switches to the requested camera (e.g., similar to FIG. 1C where the third-person video feed is selected). If a camera selection is not received, the process proceeds to 516. At 516, the cloud gaming engine, via the video camera selector function, sends the selected in-game frame render with timestamp to the player's dedicated video encoder. At 518, the cloud gaming engine, via the video camera selector function, transmits camera 1 (e.g., camera m, where m is the maximum number of player selectable player cameras), IMU data with timestamp to the cameras corresponding MPEG/KL V metadata generator (as described in FIG. 3). At 520, the encoded selected in-game camera view selection PES with timestamp is transmitted to the dedicated game player multiplexer (e.g., similar to FIG. 3, at 322 game player multiplexer) along with the encoded in-game audio AES at 522 and MPEG7/KLV metadata 524. The multiplexed data is transmitted to the sender for the user's game session, which transports the stream over the network to the game player device (e.g., similar to FIG. 1C at 132).

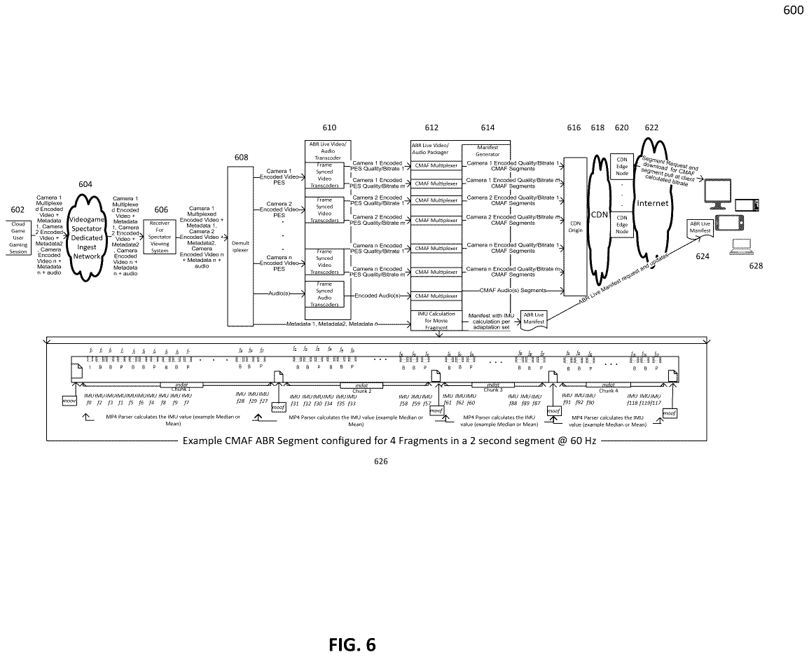

FIG. 6 shows an illustrative example of a cloud gaming architecture 600 providing a plurality of video feeds for a gaming session including an adaptive bitrate (ABR) transcoder, in accordance with some embodiments of this disclosure. This system, via a videogame spectator dedicated ingest network 604, may receive 606 the multiplexed camera views including metadata with IMU data for each frame for every available camera view from a player's gaming session 602 (e.g., similar to FIGS. 2A-C where user device 232 spectates gaming session by accessing video segments via manifest 234). This session could be from a cloud-based system (e.g., similar to FIG. 3) or it could also be from a device like a PC, console, mobile phone or tablet.

The system demultiplexes, via a demultiplexer 608, the encoded camera views, encoded audio(s) and the metadata which includes the IMU data and additional data like which camera view the player is viewing. Each of the demultiplexed camera PES data is sent to an ABR Live Video/Audio transcoder 610, where each of the camera encoded PES data is sent to a frame synced video ABR transcoder and there are multiple Frame Synced Video ABR Transcoders.

This may include a ABR live video/audio packager 612 and a manifest generator 614. An example of the common media application format (CMAF) ABR Segment configured for four fragments in a two second segment at 60 Hz can be seen at 626. The manifest generator 614 transmits the encoded CMAF segments for each respective camera to a content delivery network (CDN) origin that is forwarded to the network itself 618 and may be transmitted to a CDN edge node in some embodiments 620. The CDN edge node 620 may, via the internet 622, receive request and download from one or more user devices 628 (e.g., whereby the user device at 628 spectate the gaming session corresponding to cloud game user gaming session 602). Upon a request, the ABR live manifest also provides the corresponding addresses within the manifest to the user devices at 624.

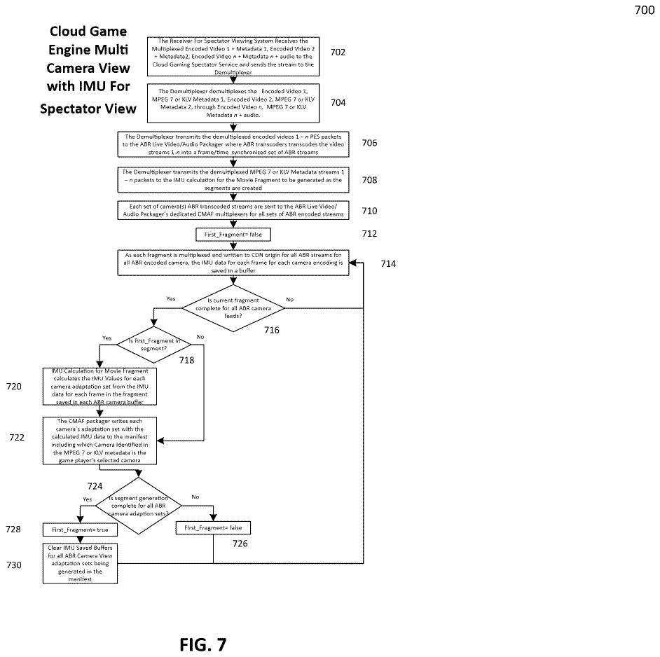

FIG. 7 shows a flow chart 700 for ABR generation. At 702, the receiver for the service (e.g., spectator viewing system) receives the multiplexed data that includes encoded video data for all cameras, the encoded MPEG7 or KLV for all cameras and the encoded audio AES packets for Spectator Viewing System (e.g., similar to FIG. 2A-C with multiple video feed 212 includes first-person video feed 206, third-person video feed 208, and overhead video feed 210). At 704, the multiplexed data is demultiplexed where each of the camera's encoded video streams are sent to their own ABR transcoders at 706. The demultiplexed MPEG7 or KLV encoded metadata is sent to the IMU calculation Movie Fragment (Moof) function at 708. The ABR transcoder may transcode each camera's video streams into their configured ABR bitrate ladders which is sent to a CMAF packager for CMAF segment generation for the camera feed encoded ABR bitrate ladders at 710. The audio AES may be transcoded into the desired audio for the service and sent to the ABR packager for CMAF audio segment generation. At step 712, the system may set a “first fragment” flag to a value to of “false.” At 714, as each fragment is multiplexed and written (e.g., to CDN origin) for all ABR streams for all ABR encoded camera views, the IMU data for each frame for each camera encoding is saved in a buffer. e. At 716, the system may determine if the generation of a current fragment is complete for all ABR camera feeds. If not, the process proceeds to loop back to 714. If yes, the process proceeds to 718, where the system may determine if it is working with a first fragment in the segment. If yes, the process proceeds to 720, if not, the process proceeds to 722 skipping the step 720. At 720, the IMU calculation logic computes the IMU Values for each camera adaptation set from the IMU data for each frame in the fragment saved in each ABR camera buffer. This calculation may be based on a median or mean of IMU values, or based any other suitable calculations based on the IMU data for the Movie Fragment (Moof). This first fragment may cover the entire segment if the fragment configuration is the same as the segment length. If the processed than proceed to 722. At 722, the CMAF packager writes each camera's adaptation set with the calculated IMU data to the manifest including which camera identified in the metadata (e.g., MPEG7/KLV) is the game player's selected camera. At 724, the system determines whether the segment generation is complete for all ABR camera adaptation sets. If not, the process sets the “first fragment” flag to “false” at 726 and reverts to 714. If yes, the process proceeds to 728. At 728, the system set the “first fragment” flag to “true” and at 730 clear IMU saved buffers for all ABR camera view adaptation sets being generated in the manifest and revert to 714.

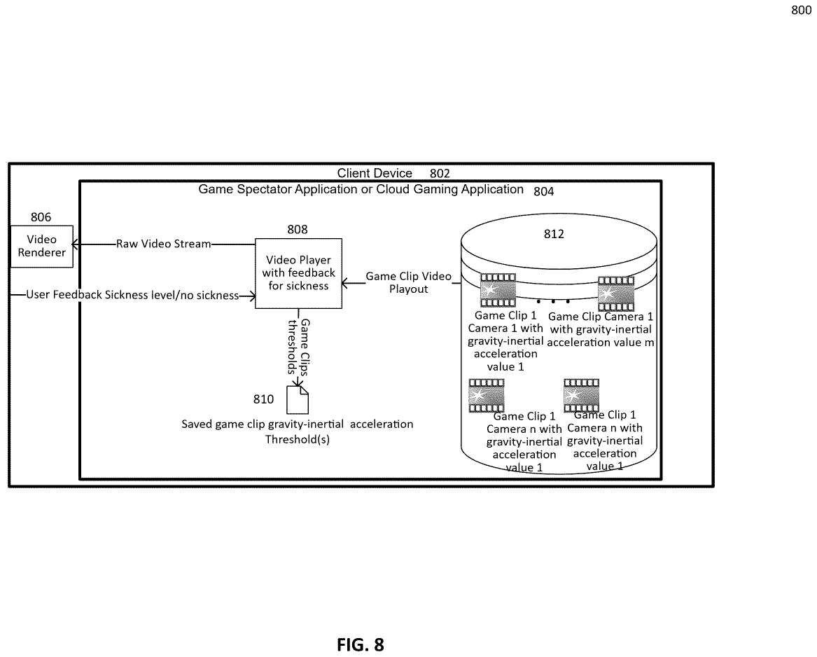

FIG. 8 shows an illustrative example 800 of a user device saving sickness thresholds, in accordance with some embodiments of this disclosure. On a client device 802 (e.g., computer, smartphone, or similar device), the game spectator or cloud gaming application 804 may play game clips with a mean or median calculated gravity-inertial acceleration based on an IMU value per video frame at 812. The cloud gaming or spectator application will play each clip and the user will select a scaled value on a level of sickness at 808 (e.g., similar to FIG. 1C at 109 with IMU calibration data to be greater than 70°/s sensitivity). Based on this, each camera view will be saved for threshold values for different camera views in a video game at 810. Each game may have its own test videos based on the available cameras selectable by a game player or a game spectator for a specific video game title. This will allow the cloud gaming or game spectator application to make adjustments based on a selected camera along with additional post processing to avoid motion sickness or ocular discomfort.

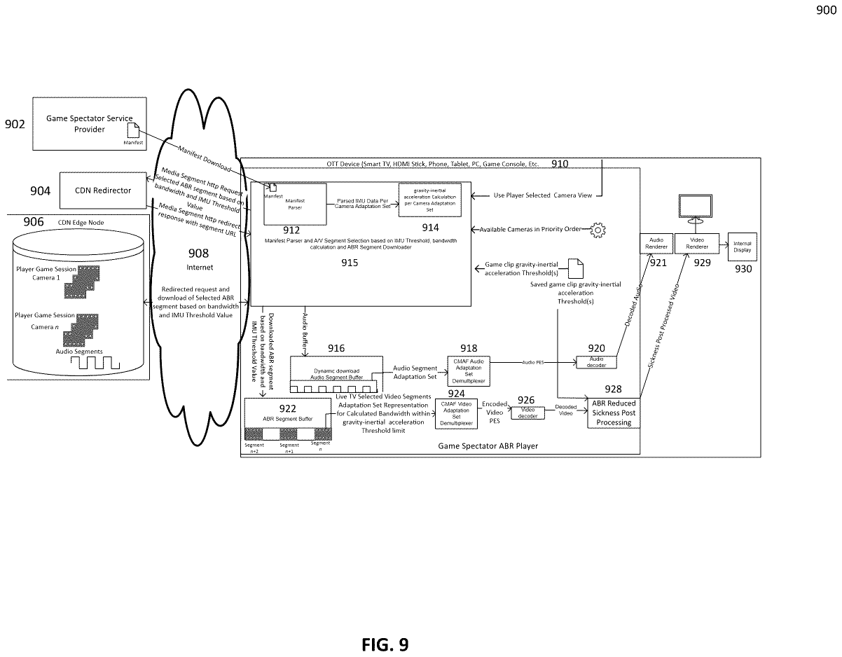

FIG. 9 shows an illustrative example 900 of an ABR system adjusting segment selection based on a saved game clip gravity-inertial acceleration threshold values, in accordance with some embodiments of this disclosure. In some embodiments, the threshold value may be set using the testing from FIG. 8. A game spectator service provider 902 transmits the manifest data to the manifest parser of the user device (e.g., OTT device 910). The CDN redirector 904 provides the media segment to the manifest parser and A/V segment selection.

The manifest parser and A/V segment selection 915 based on IMU threshold, bandwidth calculation and segment downloader parses the manifest for the adaptation sets. In some embodiments, no segments will be selected for download if the IMU threshold value is equal to or above the equivalent IMU saved game clip gravity-inertial acceleration thresholds.

This selection may be a preferred setting by the user for all camera views ordered in terms of preference. In this example, the adaptation set 914 with the top camera view in the user's preference setting that falls under the IMU threshold will be selected for segment selection to be downloaded (e.g., similar to FIG. 1C at 109 with IMU calibration data to be greater than 70°/s sensitivity). Based on the bandwidth, the selected adaptation set segment bitrate will be downloaded into the buffer to be played. Additionally, an option to use player selected camera view may be selected by the spectator. In this case, the identified camera adaptation set that is flagged in the manifest as the player's view will be selected as the adaptation set to download the segment representation that fits into the calculated available bandwidth. This is provided the IMU data does not exceed the threshold value for the spectator. If this is the case, the user device for the player will resort to an alternate camera selection that is below the gravity-inertial acceleration threshold(s) value for the spectator. This alternate may be from a prioritized list the spectator has identified that falls below the gravity-inertial acceleration threshold(s) value. Once the game player's IMU value drops below the gravity-inertial acceleration threshold(s) value, the user device will revert the spectator view to the current game player's view. In some embodiments, the ABR segment buffer 922 downloads the ABR segment based on bandwidth and IMU threshold value.

The CMAF video adaptation set demultiplexer 924 receives the live-TV selected video segments adaptation set. This set may be a representation of calculated bandwidth within a gravity-inertial acceleration threshold limit. CMAF video adaptation set demultiplexer 924 then transmits the encoded video PES with video decoder 926. The video decoder 926 may then transmit the decoded video to the ABR reduced sickness post processing 928. The ABR reduced sickness post processing 928 may transmit the video to video renderer 929 and in some embodiments to an internal display 930 (e.g., similar to FIG. 2C with user device 232). In a similar way, the dynamic download audio segment buffer 916 receives the audio from the manifest parser and A/V segment selection 915 and the transmits an audio segment adaption set of the downloaded audio segment to the CMAF audio adaptation set demultiplexer 918. The CMAF audio adaptation set demultiplexer 918 transmits the audio AES to the audio decoder 920. The audio decoder 920 may then decode the audio to the audio renderer 921.

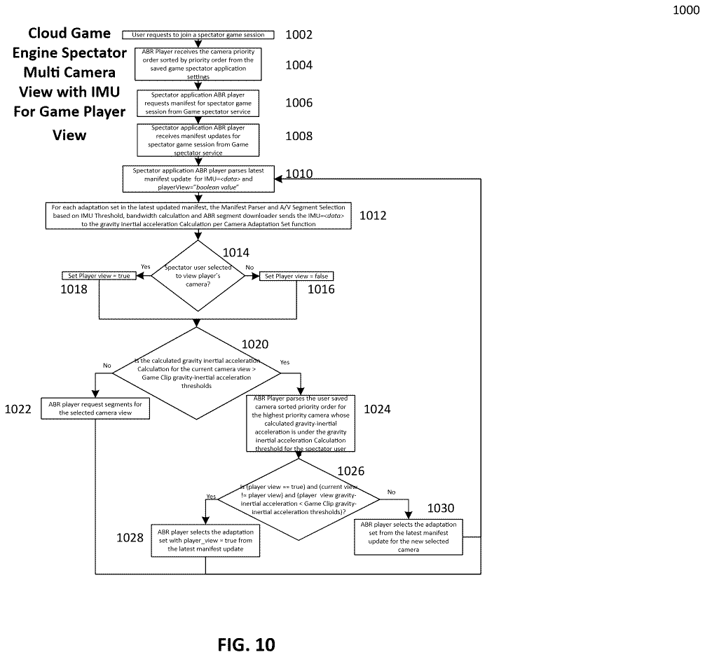

FIG. 10 shows an illustrative example 1000 of spectator camera switching based on the user selection of cameras, in accordance with some embodiments of this disclosure. In some embodiments, the user's selection may implement following the game player's camera view. In some embodiments, the cameras are switched automatically based on the calculated gravitational inertial acceleration from the IMU in the manifest adaptation sets compared to the saved user's gravitational inertial acceleration thresholds (e.g., similar to FIG. 1C at 109 with IMU calibration data to be greater than 70°/s sensitivity). At 1002, the user requests to join a spectator game session and at 1004 the ABR player receives the camera priority order from the saved game spectator application settings. At 1006 the ABR player requests the manifest for spectating the game session from the spectator service (e.g., Twitch). At 1008, the spectator application manifest updates from the spectator service, and then the application at 1010 parses the latest manifest update for IMU and player camera video feed preferences. At 1012, for each adaptation set in the latest updated manifest, the manifest parser and A/V segment selection based on IMU threshold, bandwidth calculation and ABR segment downloader transmits the IMU to the gravity inertial acceleration calculation per camera adaptation set function.

At 1014, the system determines whether a selection was received from the user device selecting for the spectator camera to match the current player camera. If true 1018, or untrue 1016, the process proceeds to 1020 where the system determines whether the calculated gravity inertial acceleration calculation for the current camera view is greater than the game clip gravity inertial acceleration thresholds. If not, the system, at 1022 (e.g., ABR player) request segments for the selected camera view. If yes, the system, at 1024, parses the user saved camera priority order for the highest priority camera whose calculated gravity-inertial acceleration is under the gravity inertial acceleration calculation threshold for the spectator user. The system at 1026 determines whether the current camera matches the player's camera and secondly whether the view gravity inertial acceleration is less than the game clip gravity inertial acceleration thresholds. If no, at 1030, the system selects the adaptation set from the latest manifest update for the newly selected camera. If yes, at 1028, the system selects adaptation set from the player view from the latest manifest update.

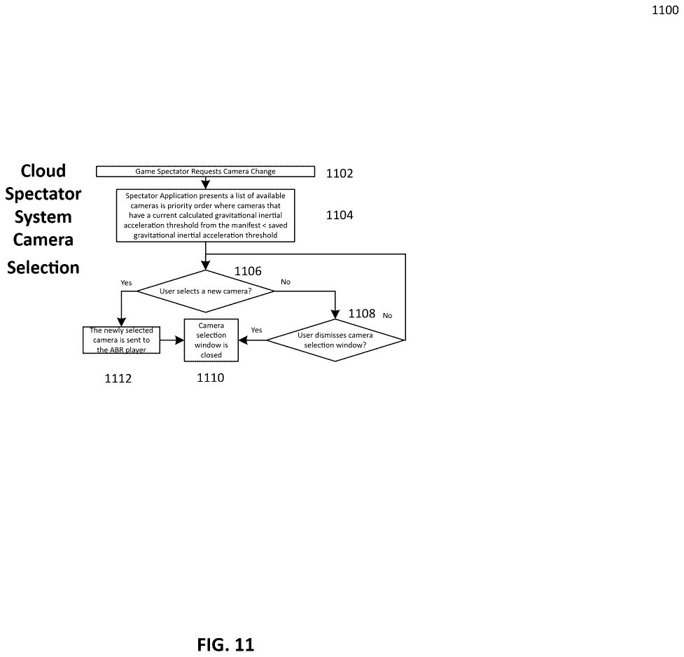

FIG. 11 shows an illustrative example 1100 of a player requesting a new camera view, in accordance with some embodiments of this disclosure. At 1102, the user device may receive input from a user selecting to change camera views. At 1104, the user device may generate for display to the user a list of prioritized cameras is displayed where only cameras that are below the threshold are presented. At 1106, the user device may determine if the user selects a new camera. If yes, the process proceeds to 1112 where the selection of the new camera is transmitted to the ABR player. If no, the process proceeds to 1108 where the user dismisses the camera selection window (e.g., user interface for selection). Subsequent to both steps 1108 and 1112, the user device closes the user interface window for camera selection at 1110.

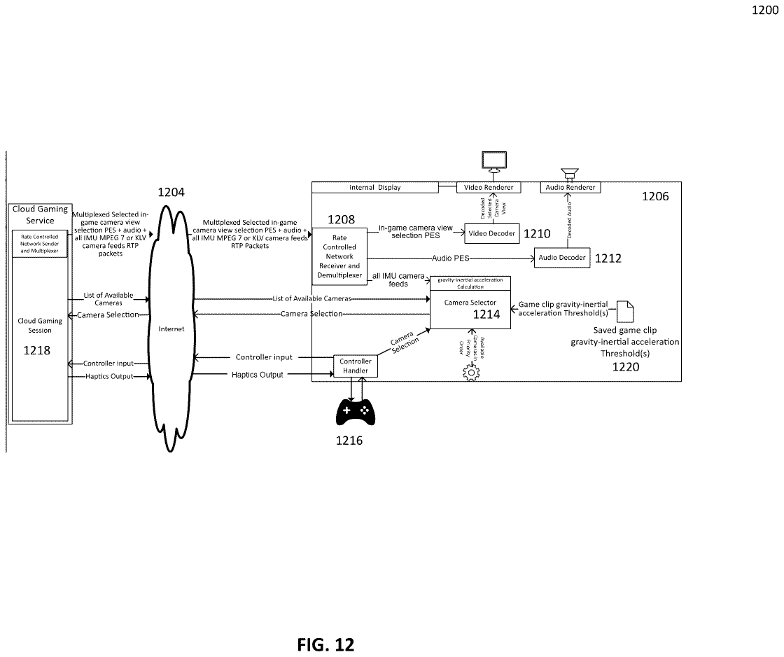

FIG. 12 shows an illustrative example 1200 of a cloud game application camera switching, in accordance with some embodiments of this disclosure. The user device 1206 (e.g., similar to user device 104 of FIGS. 1A-C) receives a rate controlled multiplexed stream at the receiver of the player selected game camera encoded Video Encoding Service (VES), the encoded audio AES(s), and MPEG 7 or KLV metadata with the IMU data for all camera feeds from a cloud gaming service 1218 (e.g., similar to COD game server 102 of FIG. 1A-C). These video VES and audio AES streams along with the MPEG 7 or KLV IMU per picture metadata are demultiplexed by the rate controlled network receiver and demultiplexer 1208. The video VES stream is sent to the video decoder 1210, decoded and the video is rendered to the user. The audio AES is sent to the audio decoder 1212, decoded and the audio is rendered to the user. All the IMU camera feeds are sent to a camera selection system 1214. This camera selection system 1214 may receive input from a user selection of a camera (e.g., via a controller 1216) and a request will be made to the cloud gaming session 1218 to change the rendered video in the cloud game session 1218 to the selected camera where it will be encoded and transported to the client gaming application. In some embodiments, the camera selection may receive input from the user selecting a priority of camera views. For example, the user may select, via the controller, that a first-person video feed is the top priority camera feed. The camera selector 1214 may retrieve the video feed priority associated with the game player and switch to the corresponding video feed in association with the video feed priority with the condition of IMU calibration data being satisfactory for the corresponding video feed.

The demultiplexed IMU MPEG 7 or KLV IMU metadata for all selectable in-game cameras is sent to the camera selection system 1214. The camera selection system 1214 will calculate the gravity inertial acceleration for each of the camera feeds including the player's current view camera. The camera selector also receives and parses the saved game clip gravity-inertial acceleration threshold values 1220 for comparison to the calculated the gravity inertial acceleration for the current camera selection to determine if the value is above the saved game clip gravity-inertial acceleration threshold values (e.g., similar to FIG. 1C at 109 with IMU calibration data to be greater than 70°/s sensitivity). If the value is above the threshold values, the camera selection system will select the highest prioritized camera from the user's saved available cameras in priority order where the calculated gravity inertial acceleration is under the saved game clip gravity-inertial acceleration threshold values. Once a camera is selected, the camera selection request will be made to the cloud gaming session for the automatic camera selection to avoid motion discomfort. The automatic switch may be undesirable for some gamers and therefore a system would provide the capability to switch the feature on or off based on the user's preference.

The system may determine a camera priority order, which does not lead to ocular discomfort, and the stream of select camera or perspective may start streaming. This system determination on the perspective for a spectator may be leveraged to significantly reduce latency at the switch and improve the overall QoE, in the case of live streaming for gaming and game spectating. When a new scene or perspective occurs at such a switch, the picture size of the newly encoded frame (an IDR, I-frame, or a predictive frame) usually results in a spike in bitrate. This has been a well-known challenge in getting such a large picture delivered in time for decoding and presentation, especially in low latency use cases. When the system determines an opportunity of switching, the operations of video encoding and streaming for the current and new camera or perspective can be better optimized. Based on determining a switch, the system may trigger an IDR or I-frame encoding immediately for the video of new perspective. This may ensure, at the replacement of a camera, that the new perspective may be delivered and presented to the user with a minimum latency. Since the determining is done by the system, a more preventive encoding and streaming process can take place even before the actual switch. This is useful when delivering large I-pictures, which may cause a latency issue. The switch may occur when the minimum-latency frames (following an I-frame) of a new perspective become available for presentation.

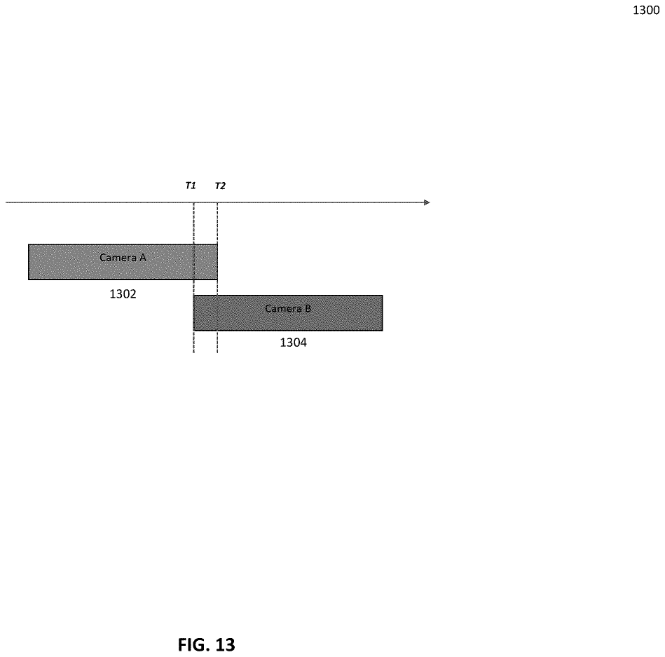

FIG. 13 shows an illustrative example 1300 of a temporal diagram for detection of a selection to switch cameras, in accordance with some embodiments of this disclosure. At time T1, the system (e.g., game server of FIGS. 1A-C, or streaming server of FIGS. 2A-C) detects a need to switch from camera A 1302 to camera B 1304. The encoding and streaming of video from camera B 1304 will then kick off at time T1. In the case of limited bandwidth, the large IDR frame of camera B 1304 may take longer than a frame duration. In the example, at time T2, the decoded frames of camera B 1304 become available for presentation so that the user does not experience lagging from the live game. Note that, the switch of presentation from camera A 1302 to camera B 1304 occurs at time T2. The video of camera A may continue streaming and playing between T1 and T2, at a reduced bitrate to provide a continuous transition. Video quality from various cameras or perspectives may be considered in the determining of potential that leads to a user's motion discomfort. A perspective with complex scene rendering of rich spatial and temporal detail may lead to severe compression artifacts. At the determining of degraded and compromised video quality, the system may also trigger a switch to a new perspective that offers better visual quality from the cameras available in priority order.

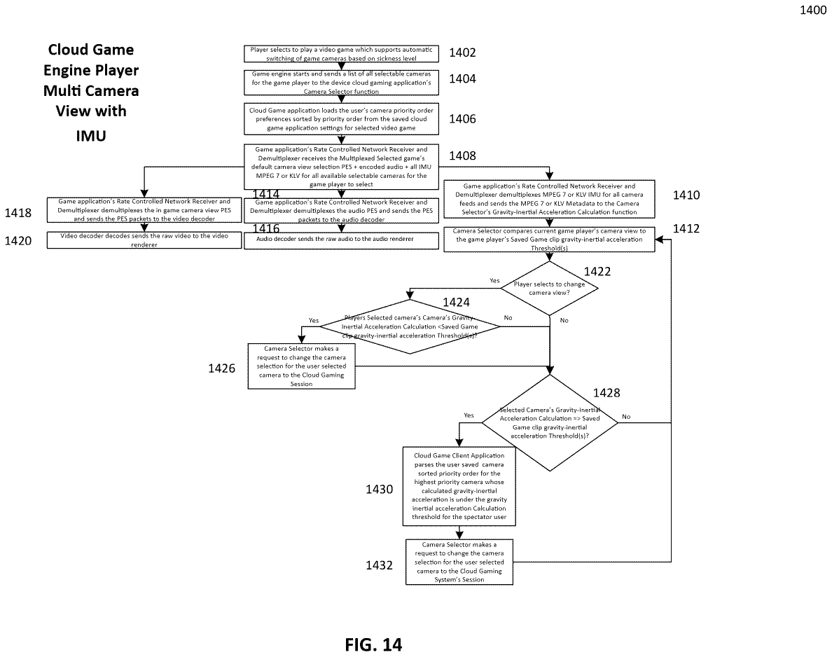

FIG. 14 shows an illustrative example 1400 of a temporal diagram for a player selection to switch cameras, in accordance with some embodiments of this disclosure. In some embodiments, the player may make a selection for a different camera of the plurality of cameras (e.g., video feeds). In other embodiments, the user device may provide a selection for the camera to switch automatically based on the calculated gravitational inertial acceleration from the demultiplexed MPEG 7 or KLV IMU data for the current selected camera as well as the IMU data for all available cameras in the incoming multiplexed data stream. The IMU data for all cameras is used to calculate a gravitational inertial acceleration for each of the cameras. The currently selected camera's calculated gravitational inertial acceleration is compared to the game player's saved gravitational inertial acceleration thresholds. If the currently selected camera goes above the calculated threshold, a new camera will be selected for the player's view which will be the player's highest prioritized camera that is below the saved gravitational inertial acceleration thresholds. At 1402, the game server receives selection from the user device that the player has selected to play a video game that supports automatic camera switching based on sickness level. At 1404, the game server provides a list of all potential cameras (e.g., video feeds) in relation to the gaming session to the user device (e.g., similar to FIG. 1A with video feeds 106, 108, and 110). At 1406, the user device, via a cloud gaming application (e.g., Call of Duty application), loads the user's camera priority order preferences for the particular cloud gaming application. At 1408, the user device, via a cloud gaming application's rate controlled network receiver and demultiplexer receives the multiplexed game data including the default camera video feed and view selection VES, audio AES, IMU data for all cameras, and metadata for the game player to select. At 1418, the gaming application's rate controlled network receiver and demultiplexer demultiplexes the in-game camera view VES and transmits VES packets to the video decoder and at 1420, the video decoder decodes the VES packets and transmits the raw video data to the video renderer. At 1414, the gaming application's rate controlled network receiver and demultiplexer demultiplexes the audio PES and transmits the VES packets to the audio decoder, and at 1416 the audio decoder sends the raw audio to the audio renderer. At 1410, the gaming application's rate controlled network receiver and demultiplexer demultiplexes the received data and transmits the metadata to the camera selector module (within the gaming application). At 1412, the camera selector module compares the current camera selection to the player's saved game clip gravity-inertial acceleration thresholds. At 1422, if the player selects to change their camera, the process proceeds to 1424. At 1424, the camera selector makes a determination of whether the player's selected camera's camera gravity-inertial acceleration calculation is less than the player's saved game clip gravity-inertial acceleration thresholds. If yes, the process proceeds to 1426 where the camera selector requests to change the camera selection from the currently selected camera for the current cloud gaming session and the process proceeds to 1428. If no, the process proceeds to 1428 with no change in camera. At 1428, the camera selector determines if the selected camera gravity-inertial acceleration calculation is greater or equal to the player's saved game clip gravity-inertial acceleration thresholds. If yes, the process proceeds to 1430 where the gaming application parses the user saved camera sorted priority order for the highest priority camera that has camera gravity-inertial acceleration calculation less than the player's saved game clip gravity-inertial acceleration thresholds. At 1432, the camera selector requests to change the camera to the highest priority camera.

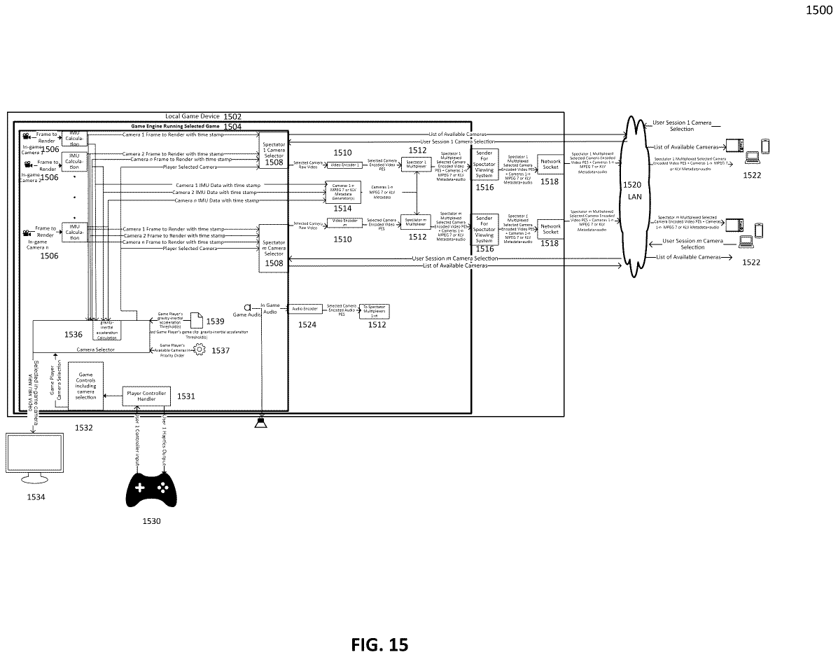

FIG. 15 shows an illustrative example 1500 of a local video game console gaming system on a local area network, in accordance with some embodiments of this disclosure. In some embodiments, extreme low latency spectator views are required since a local game device 1502, running the selected game on a game engine 1504 (e.g., a Sony Play Station device is running a COD gaming session, another device (e.g., smartphone) can view other camera views in the same room as the game player. For example, if a local game player is playing COD on a Play Station but another user other than the local game player cannot physically watch the game session on the Play Station due to ocular discomfort, the other user may spectate the game player's gaming session via another local LAN device (e.g., a watching the COD gaming session on their personal smartphone). The Play Station and the smartphone are on the same LAN network ensuring low latency. The frame latency will be extremely close to the game player since it is delivered over the LAN and in most cases, network reliability, latency and bandwidth will not be an issue. Each spectator instance will have a camera selection system 1506, a video encoder 1510, a multiplexer 1512 and a sender 1516 for spectator viewing system 1522 (e.g., smartphones, televisions, laptops). Each of the in-game camera video feeds will be sent to both a camera selector 1508 for the player and a camera selector 1508 for each of the spectators. All the camera's feeds will also include a system timestamp. The spectator camera selector 1508 will output the raw video with timestamp data from the in-game selected camera that is selected from the spectator's device 1502.

The raw video feed will be fed into a video encoder 1510 instance for the spectator. The encoded and packetized video VES will be sent to a dedicated spectator multiplexer 1512. In-game audio is received by an audio encoder 1524 that transmits the encoded audio AES to the spectator multiplexers 1512. A MPEG7, KLV or SEI metadata generator 1514 will receive IMU data feeds from all the in-game camera IMU calculation systems on a per frame basis with a corresponding timestamp that will match a corresponding video frame. The methods for generating the IMU data were covered earlier in this disclosure. The multiplexed selected camera encoded video VES and all the camera IMU MPEG7/KLV or SEI data feeds may generate a manifest that will be sent via a sender 1516, via a network socket 1518, over the LAN 1520 to a spectator application running on the spectator's client device 1522 (e.g., returning to the earlier example, the smart television spectating the COD gaming session). The spectator device 1522 may select from the manifest different cameras on the gaming device for viewing or this may be automatically selected based on a sickness threshold (e.g., similar to FIG. 2C where video segments are accessed based in part on satisfactory IMU parameters). If the client device 1502 (e.g., game player on PC device) makes a camera selection, the spectator camera selector 1508 will switch to the raw video for the selected in game camera which will be encoded and transported to the spectator's device 1522 for viewing. The local device 1502 may include a user input device (e.g., a controller 1530), via a player controller handler that transmits the input to a game controls camera selector 1532 which then forwards the selection to the player camera selector 1536. The selected in-game camera view raw video 1534 is also received by the player camera selector 1536. The player camera selector 1536 may also receive the game player's available cameras in priority order 1537 and the game player's gravity-inertial acceleration thresholds 1539.

In some embodiments, the local game device 1502 may include automatic switching of cameras based on a sickness threshold. The camera selector system 1536 receives all available cameras video feeds for the game player. The user may, via user input, make a selection to switch to any of the cameras for viewing using the controller 1530. Additionally, the camera selector system 1536 also includes a gravity inertial acceleration calculation function 1539. All IMU data with timestamps and corresponding timestamped video frames for each camera are sent to the camera selector system 1536. An inertial gravitational acceleration is calculated for each of the camera views. If the local gaming device 1502 has received selection to automatically switch cameras based on an inertial gravitational acceleration threshold, the camera selector system 1536 will automatically switch to an alternate camera view if the current view exceeds the game player's inertial gravitational acceleration threshold 1539. A PC gaming device can have many profiles associated with it. In this embodiment, the camera selector system 1536 may support an inertial gravitational acceleration threshold 1539 per user profile.

When the inertial gravitational acceleration threshold is exceeded, the camera selector system 1536 will analyze each of the camera's IMU feeds to determine which feeds fall below the game player's inertial gravitational acceleration threshold 1539. The system will select the camera view that is the game player's highest prioritized camera 1537 that falls under the player's inertial gravitational acceleration threshold.

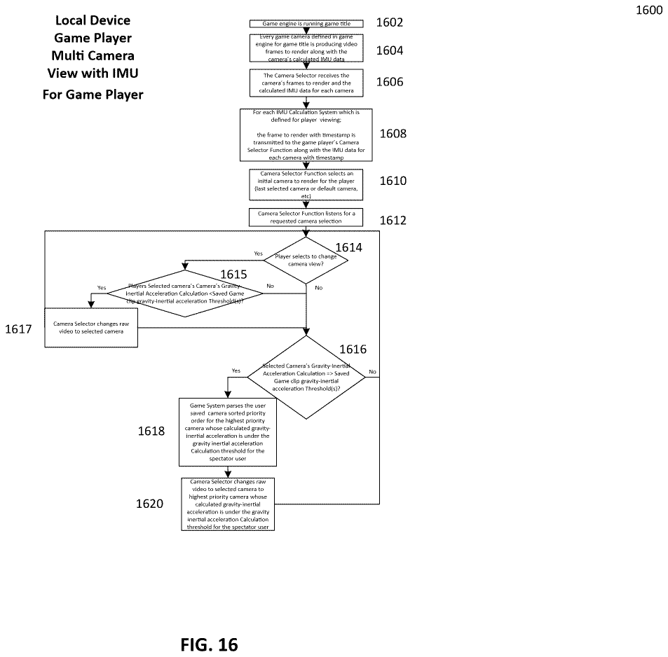

FIG. 16 is a flowchart 1600 of camera selection based on the player's requested camera view and a calculated sickness threshold, in accordance with some embodiments of this disclosure. At 1602, the game engine may execute the game title. At 1604, the game engine generates video frames to render for every game camera along with IMU data. At 1606, the camera selector receives video frames to render for every game camera along with IMU data. At 1608, for each IMU calculation system that is defined for playing viewing, the frame to render with timestamp is transmitted to the game player's camera selection function along with the IMU data for each camera with timestamp. At 1610, the camera selector function selects an initial camera to render for the player. At 1612, the camera selector function may receive a requested camera selection from the user device (e.g., similar to the personal computer 104 in FIG. 1A selecting multiple video feeds 106, 108, and 110). At 1614, the player may select, via user input from the user device to the game server, to change the camera view. If the player does not change the camera view, the process proceeds to 1616. At 1616, the camera selector function may determine whether the selected camera's gravity inertial acceleration calculation is greater than or equal to the saved game clip gravity-inertial acceleration thresholds. If not, the process proceeds to 1620. If yes, the process proceeds to 1618. At 1618, the game server may parse the user saved camera sorted priority order for the highest priority camera that has camera gravity-inertial acceleration calculation less than the player's saved game clip gravity-inertial acceleration thresholds. At 1620, the camera selector requests to change the camera to the highest priority camera. At 1615, the camera selector function may determine whether the player selected camera's gravity inertial acceleration calculation is less than the saved game clip gravity-inertial acceleration thresholds. If no, the process proceeds to 1616. If yes, the process proceeds to 1617. At 1617, the camera selector changes the raw video feed to the selected camera.

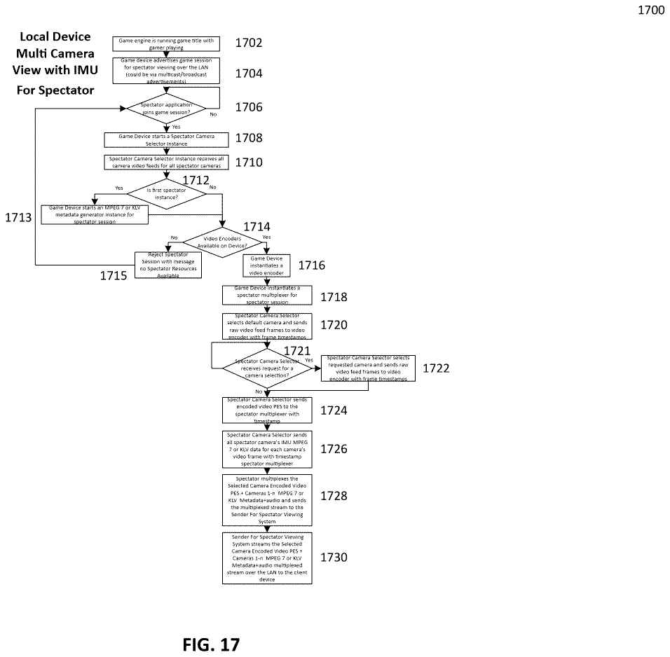

FIG. 17 shows an illustrative example 1700 of a local device performing camera selection based on a spectator's requested camera view and a calculated sickness threshold, in accordance with some embodiments of this disclosure. In some embodiments, each spectator has a dedicated camera selector, video encoder and multiplexer. The spectator, via user input, selects a camera for viewing the game play. The raw in-game selected camera video feed is sent to the spectator's dedicated video encoder. All camera feeds IMU calculation per video frame is sent to an MPEG 7 or KLV metadata generator. The encoded video VES, audio AES and all MPEG 7 or KLV camera encodings are sent to the player's dedicated multiplexer where the streams are multiplexed and sent to a Sender for Spectator Viewing System over the Local Area Network (e.g., similar to FIG. 2C where the manifest provides video segments for the user device to spectate).

At 1702, the game server may execute the game title. At 1704, the user device advertises a game session for spectator viewing over the LAN. At 1706, the game device makes a determination whether the spectator joins the gaming session. If no, the process awaits a spectator to join the gaming session. If yes, at 1708, the game server starts a spectator camera selector instance. At 1710, the spectator camera selector instance receives all camera video feeds for all spectator cameras. At 1712, the spectator camera selector determines whether this is the spectator's first instance spectating. If no, the process proceeds to 1713 where the game device starts an MPEG 7/KL V metadata generator instance for the spectator session. If yes, the process proceeds to 1714. At 1714, the spectator camera selector determines whether there are video encoders on the user device. If no, the spectator session is rejected with a message that no spectator resources are available. If yes, the process proceeds to 1716. At 1716, the user device instantiates a video encoder, and a spectator multiplexer for the spectator session 1720. At 1721, the spectator camera selector receives a request for a camera selection. If yes, at 1722, the spectator camera selector selects the requested camera and transmits the raw video feed frames to the video encoder with timestamps. If no, the process proceeds to 1724. At 1724, the spectator camera selector transmits the encoded video VES to the spectator multiplexer with timestamps and, at 1726, sends all spectator camera IMU MPEG7/KLV metadata with timestamps to the multiplexer. At 1728, the spectator multiplexer multiplexes the received data into a stream and transmits the stream to the sender for a spectating viewing system. At 1730, the sender for spectator viewing system streams the received stream and spectates the gaming session.

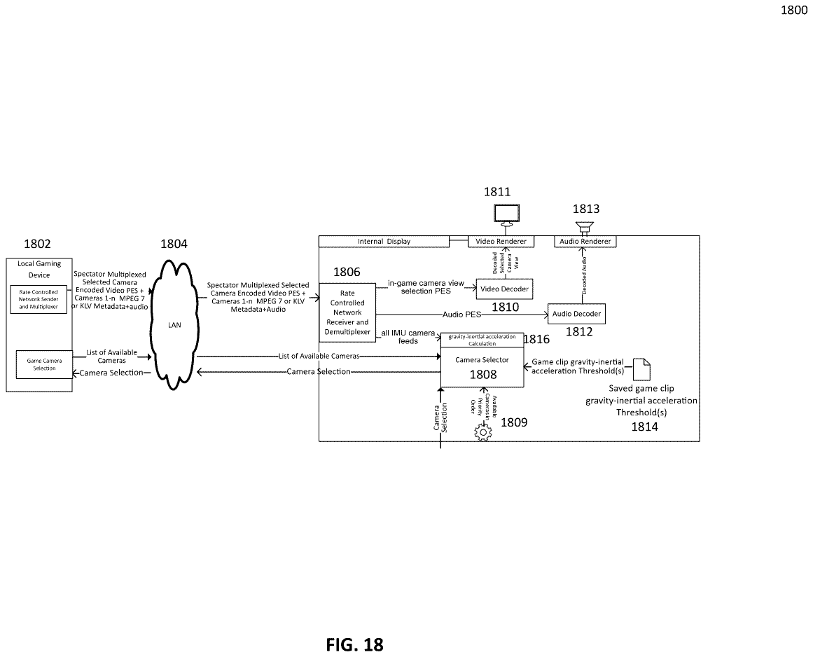

FIG. 18 shows an illustrative example 1800 of a user device running an application for spectating connected to a local area network, in accordance with some embodiments of this disclosure. In some embodiments, the game system may be a console-based system or running on a personal computer. The camera selector system 1808 may receive the selected camera feed along with the IMU data for all available cameras for spectator viewing (e.g., similar to FIG. 2A receiving video feeds first person video feed 206, third person video feed 208, and overhead video feed 210). The multiplexed stream from the local gaming device 1802 containing the selected encoded camera, all camera IMU MPEG 7, KLV data are transmitted, via a LAN 1804, to the rate-controlled network receiver and demultiplexer 1806 where the multiplexed stream is demultiplexed. The in-game camera view selection video VES is sent to the video decoder 1810 where it is decoded rendered to the display 1811. The demultiplexed in-game audio is sent to the audio decoder 1812 where it is decoded and sent to the audio renderer 1813. All IMU camera feeds is sent to the camera selector's gravity inertial acceleration calculation 1816. A comparison is made to the saved game clip gravity-inertial acceleration threshold values 1814. If the current camera being viewed by the spectator is above the saved threshold value, the camera selector system will filter all camera IMU values that is below the saved game clip gravity-inertial acceleration threshold values. The user ordered highest priority camera 1809 that is below the saved game clip gravity-inertial acceleration threshold values will be selected for the new view for the spectator. The camera selector system will make a camera selection to the local gaming device 1802. The local gaming device 1802 will perform the switch as defined in the system diagram description in FIG. 8.

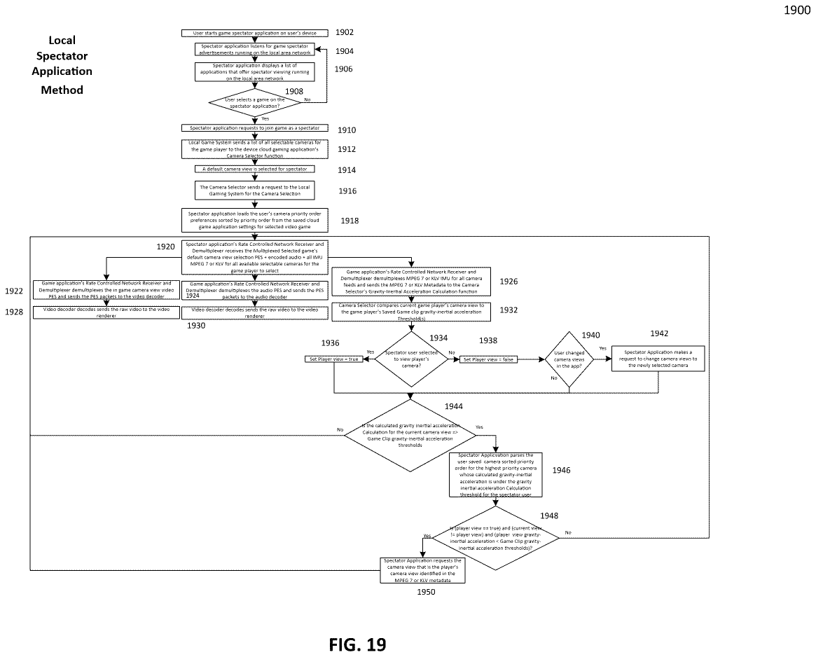

FIG. 19 shows a flowchart 1900 of a spectator's application running on a user device on the same local area network as a gaming device offering a spectator service, in accordance with some embodiments of this disclosure. The spectator application may receive a multiplexed transport stream with the selected camera encoded and packetized video VES, the audio AES and all IMU MPEG 7 or KLV encoded data streams. If the selected camera feed's calculated gravitational inertial acceleration exceeds the saved gravitational inertial acceleration threshold, the highest user's prioritized camera that is below the saved gravitational inertial acceleration threshold will be requested for the selected camera. In some embodiments, this method may also consider if the spectator selected to follow the player. In this case, if the current player's camera's calculated gravitational inertial acceleration exceeds the saved gravitational inertial acceleration threshold (e.g., similar to FIG. 1C at 109 with IMU calibration data greater than 70 degrees per second sensitivity), the highest user's prioritized camera that is below the saved gravitational inertial acceleration threshold will be requested. If the player's view was selected and the player's camera's calculated gravitational inertial acceleration falls below the saved gravitational inertial acceleration threshold, a request to select the player's current camera view will be made to switch back to the player's view.

At 1902, a user may initiate the game spectator application on their user device (e.g., selecting the Play Station app from their game console). At 1904, the spectator application determines if there are available game sessions to spectate. At 1906, the spectator application generates for display a list of applications that offer spectator viewing running on the LAN (e.g., COD, Counter-Strike). At 1908, the spectator application determines whether a selection was made for a gaming session. If no, the process reverts to 1904. If yes, the process proceeds to 1910. At 1910, the spectator application requests to join the gaming session as a spectator. At 1912, the game server transmits a list of all selectable cameras for the game player to the user device's camera selection function. At 1914, a default camera is selected for the spectator. At 1916, the camera selection function transmits a request to the game server for the camera selection. At 1918, the spectator application loads the user's camera priority order preferences sorted by priority order from the saved cloud game application settings for the selected video game. At 1920, the spectator application rate controlled network receiver and demultiplexer receives the multiplexed game data including the default camera video feed and view selection VES, audio AES, IMU data for all cameras, and metadata for the game player to select.

At 1922, the gaming application's rate controlled network receiver and demultiplexer demultiplexes the in-game camera view video VES and transmits VES packets to the video decoder and at 1928, the video decoder decodes the video VES packets and transmits the raw video data to the video renderer. At 1924, gaming application's rate controlled network receiver and demultiplexer demultiplexes the audio AES and transmits the audio AES packets to the audio decoder, and at 1930 the audio decoder sends the raw audio to the audio renderer. At 1926, gaming application's rate controlled network receiver and demultiplexer demultiplexes the MPEG7/KLV metadata and transmits the data to the camera selector gravity-inertial acceleration calculation function, and at 1932 the camera selector compares the current camera selection to the player's saved game clip gravity-inertial acceleration thresholds.

At 1934, if the spectator selects to change their camera, the process proceeds to 1944 after setting the value for set player view to true at 1936. At 1944, the camera selector makes a determination of whether the player's selected camera's camera gravity-inertial acceleration calculation is greater than or equal to the game clip gravity-inertial acceleration thresholds. If yes, the process proceeds to 1946 where the gaming application parses the user saved camera sorted priority order for the highest priority camera that has camera gravity-inertial acceleration calculation less than the player's saved game clip gravity-inertial acceleration thresholds. At 1948, the spectator application determines if the current gravity-inertial acceleration calculation of the selected camera is less than the game clip gravity-inertial acceleration threshold. If no, the process reverts to 1920. If yes, the process proceeds to 1950. At 1950, the spectator application requests the camera view that is the player's camera view identified in the metadata.

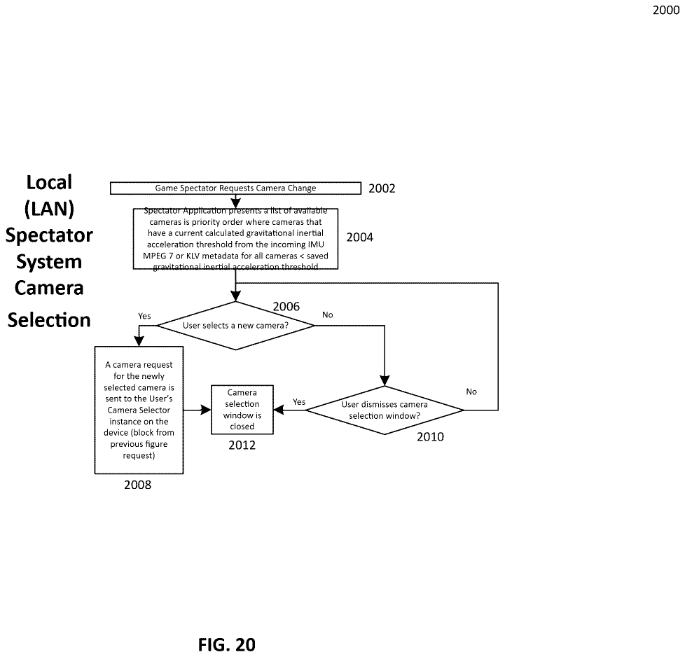

FIG. 20 shows a flowchart 2000 of a request for a new camera view from the spectator service, in accordance with some embodiments of this disclosure. In some embodiments, a player may select a change in camera via user input 2002 (e.g., similar to FIG. 1 with inputs from controller 114 received by the COD game server through the user device). The list of prioritized cameras is displayed to the user 2004 where only cameras that are below the threshold are presented. A determination is made whether the user selected, via UI selection, a new camera at 2006. If no, the process proceeds to 2010 where the UI window selection window is dismissed. If yes, a camera request for the newly chosen camera will be sent to the user's camera selection instance on the local gaming device 2008. Subsequent to steps 2008 and 2010, the camera selection window is closed 2012.

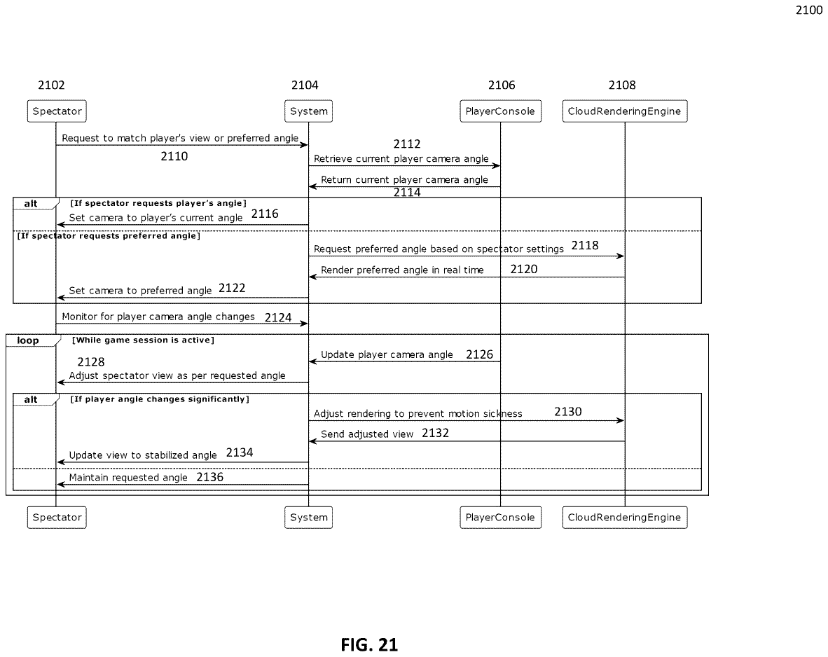

FIG. 21 shows a sequence diagram 2100 of a user device playing a game while outputting the gameplay session to a spectating platform, in accordance with some embodiments of this disclosure. The sequence includes a spectator 2102 (e.g., a user device for spectator), a system 2104 (e.g., spectating server), a player console (e.g., a user device to facilitate a gaming session), and a cloud rendering engine 2108. In some embodiments, a local game console plays a game while outputting the gameplay feed to a streaming platform, such as Twitch, and simultaneously transmitting game state data to a cloud-based game rendering engine. This configuration enables remote spectators to view the game from customizable perspectives rendered in real time by the cloud-based engine, allowing each spectator to select a preferred viewpoint, such as first-person, third-person, or a bird's-eye view, without impacting the main stream produced by the local console. The local console operates in its standard mode, delivering the primary video output to the streaming platform for broad distribution. Concurrently, it transmits game state data, including positional, camera, and environmental data, to the cloud-based rendering engine. The cloud-based engine processes this data to produce alternative views that remain synchronized with the actual gameplay. Spectators accessing these alternative views can dynamically adjust their perspective, with the rendering engine computing and delivering each personalized view in real time. At 2110, the system receives a request to match the player's view or preferred angle and retrieves the current camera angle 2112 from the player console 2106 which is returned 2114. The system may request to set the camera to the player's current camera 2116 or the spectator may request a preferred angle based on spectator settings 2118. The system receives the preferred angle in real time 2120 and sets the camera on the spectator device accordingly 2122. The system monitors for player camera angle changes 2124 and may update the camera angle 2126 received from the player console 2106 and adjust the spectator view accordingly 2128 on the spectator device 2102. If the player angle changes significantly, the system may adjust rendering to prevent motions sickness 2130 which involves the cloud rendering engine 2108. An adjusted view is received by the system at 2132 and transmitted to the spectator device 2102 to update view 2134 and maintain the requested angle 2136.

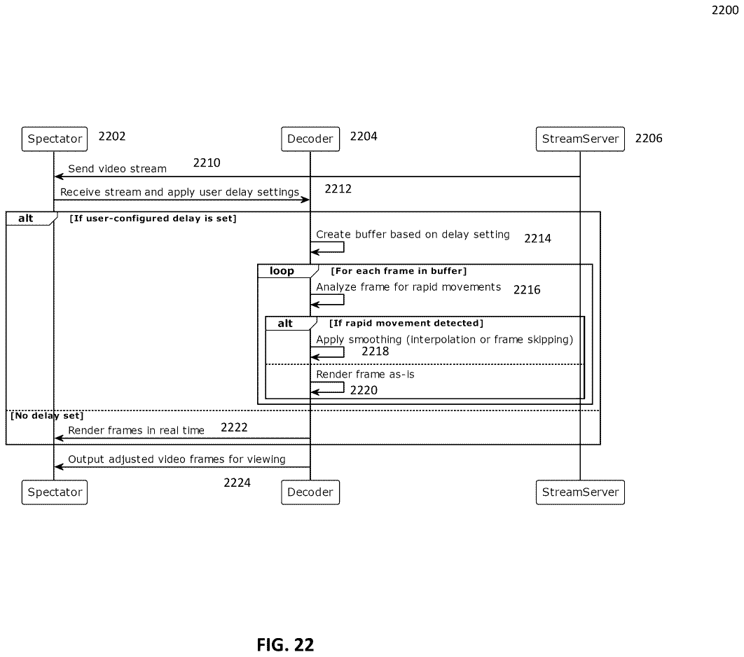

FIG. 22 shows a sequence diagram 2200 in which an algorithmic delay is applied on each spectator's device to reduce motion sickness without altering the main video stream, in accordance with some embodiments of this disclosure. In some embodiments, a buffer is generated at the decoder such that it processes each frame sequence locally, detecting rapid movements and applying smoothing techniques such as frame interpolation or selective frame skipping based on user preferences. By implementing the delay solely at the decoder, the system preserves low latency, compatibility with adaptive bitrate streaming, and scalability across devices, leveraging local GPU resources to minimize motion-sickness triggers effectively and maintain a stable viewing experience for each user independently. The sequence includes a spectator 2202 (e.g., a user device for spectator), a decoder 2204 (e.g., part of the user device), and a streaming server 2206 (e.g., Twitch server). The spectator receives a video stream from the streaming server 2210 and applies user delay settings 2212. The decoder may create a buffer based on the delay setting 2214 and for each frame in the buffer, analyze the frame for rapid movements 2216. If detected, the decoder applies smoothing (e.g., interpolation) 2218 and renders the frame 2220. The decoder then renders the frame in real time 2222 and outputs the adjusted video frames for viewing 2224 to the spectator deice 2202.

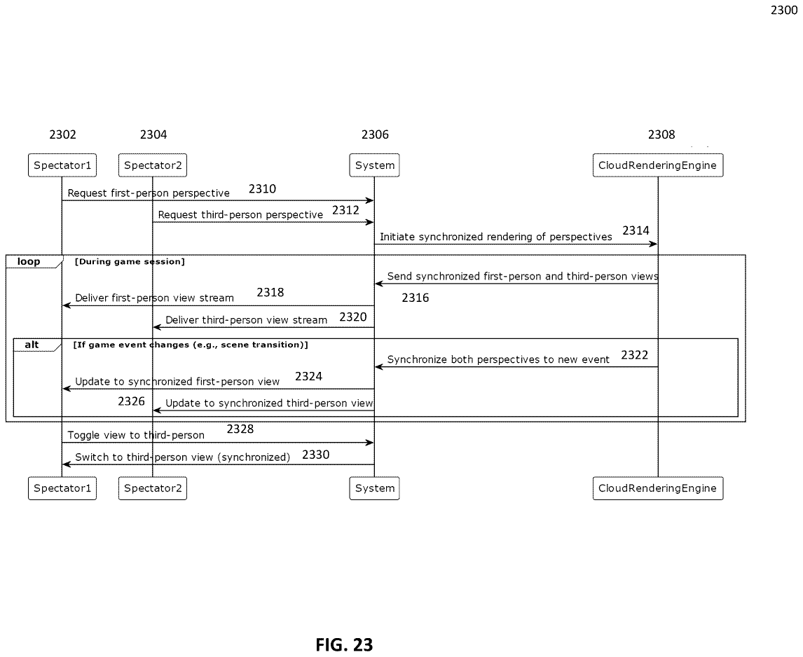

FIG. 23 shows a sequence diagram 2300 of synchronized viewing from multiple perspectives for spectators watching the same game session, in accordance with some embodiments of this disclosure. In some embodiments, the system may allow synchronized viewing from multiple perspectives for spectators watching the same game session. For example, a spectator group may select complementary views (e.g., one user watches from a first-person perspective while another views from a third-person perspective), and the system may configure these perspectives to be synchronized and match game events in real time. This feature may enhance engagement while allowing users to toggle between synced views without creating disorienting transitions. The sequence includes a spectator 1 2302 and spectator 2 2304 (e.g., user devices for spectators), a system 2306 (e.g., a streaming system such as Twitch), and a cloud rendering engine 2308. The system 2306 may receive a first-person perspective request 2310 from spectator 1 2302 and a third-person perspective request 2312 from spectator 2 2304. The system 2306 may then initiate a synchronized rendering of perspectives 2314 via the cloud rendering engine 2308. Receiving the synchronized views, the system 2306 delivers the first-person view stream 2318 to spectator 1 2302, and the third-person view stream 2320 to spectator 2 2304. If the game event changes, the system receives synchronized perspectives to a new event 2322 and updates the first person view 2324 and updates to synchronized third-person view 2326. Spectator 1 2302 may toggle to third-person view 2328. This third-person view will be synchronized 2330 as received from the system 2306.

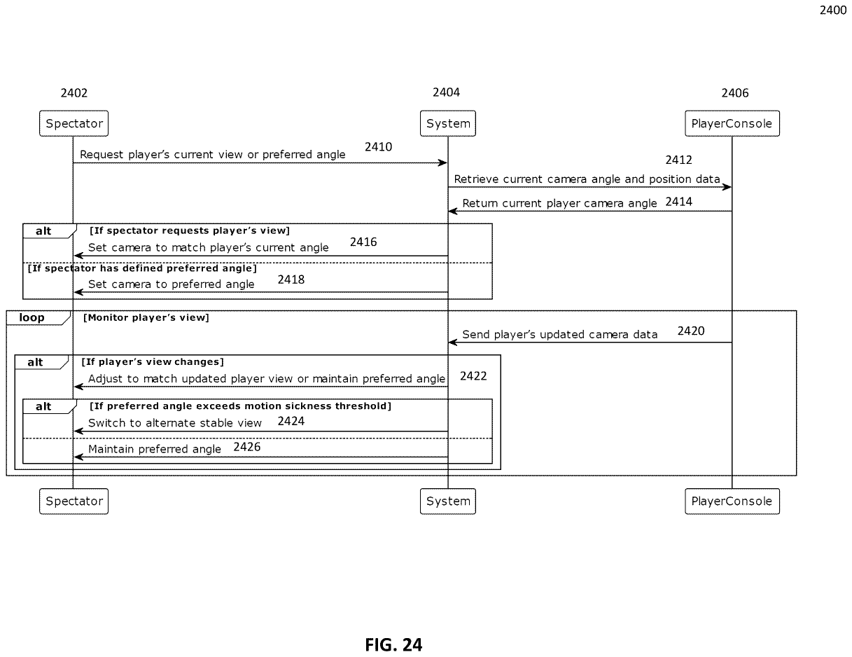

FIG. 24 shows a sequence diagram 2400 for automatic camera angle selection, in accordance with some embodiments of this disclosure. In some embodiments, the system may enable automatic camera angle selection based on a spectator's request for the same viewpoint as the player's current in-game view or a preferred angle specified by the spectator. When a spectator initiates a request to match the player's perspective, the system may identify the player's current camera angle and automatically adjust the spectator's view to synchronize with it. This feature may allow for spectators to experience gameplay from the player's exact viewpoint, enhancing immersion and engagement. If the spectator has defined a preferred angle, such as a specific third-person perspective or a wide field of view setting, the system may prioritize this angle when possible, adjusting dynamically to maintain alignment with the player's activity while also honoring the spectator's viewing preference. The system may monitor the player's camera data in real time, and when the player's view shifts, it evaluates whether the spectator's preferred angle remains feasible without inducing motion sickness or exceeding gravitational inertial acceleration thresholds. If the preferred angle is incompatible (e.g., during high motion sequences), the system may temporarily switch to an alternate stable view and revert to the spectator's preferred angle when conditions permit.

The sequence includes a spectator 2402 (e.g., a user device for spectators), and a system 2404 (e.g., a Twitch server), and a player console 2406 (e.g., Sony PlayStation). The system 2404 may receive a request for a change of view or preferred angle from the spectator 2410 and retrieve the current camera game angle 2412 from the player console 2406 that returns this data 2414. If the spectator 2402 requests the player's view, the system 2404 sets the camera to match the player's current angle 2416 or sets the camera to the preferred angle 2418. The system 2404 may receive updated camera data 2420 from the player console 2406 and adjust the view 2422 at the spectator device 2402. If the preferred angle exceeds the motion sickness threshold, the system may switch to an alternate stable view 2424 and maintain this preferred angle 2426.

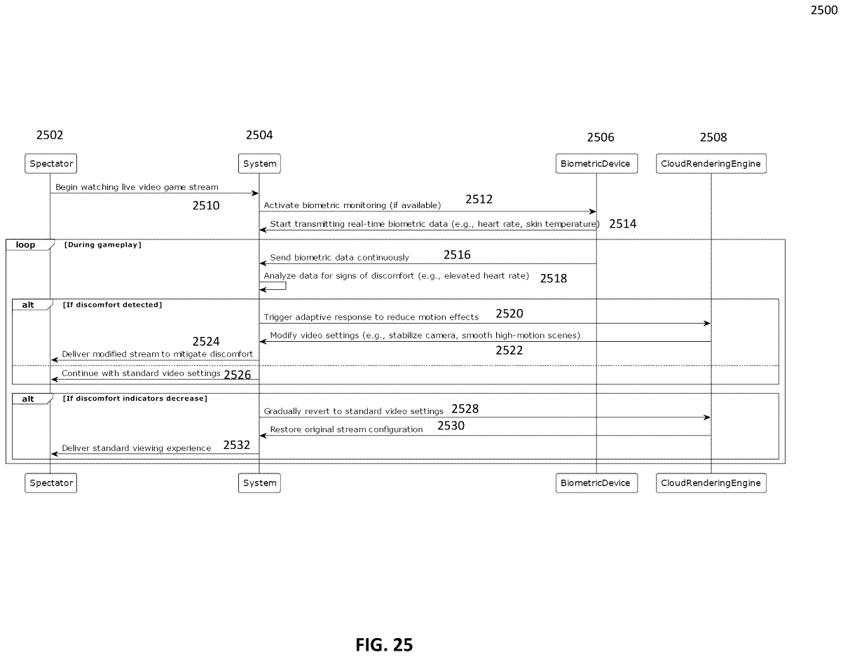

FIG. 25 shows a sequence diagram 2500 for spectator discomfort detection or signs of motion sickness using real-time biometric data, in accordance with some embodiments of this disclosure. When a spectator 2502 begins watching a live video game stream, the system 2504 activates a biometric monitoring device 2506 if compatible devices are available. This module 2506 collects biometric data, such as heart rate, skin temperature, or other physiological indicators, and transmits it to the system 2504 continuously throughout the viewing session. The system 2504 analyzes this incoming data to detect patterns associated with discomfort or potential motion sickness, such as an elevated heart rate or increased skin temperature. Upon identifying signs of discomfort, the system 2504 triggers an adaptive response in the video stream, modifying the visual output to reduce motion effects. Adjustments may include stabilizing the camera, reducing rapid movements, or smoothing high-motion scenes, all of which aim to mitigate sensory triggers that can lead to discomfort. This biometric-driven adjustment operates in real time, with the system continuously monitoring the biometric data to ensure the spectator's comfort level is maintained. If discomfort indicators decrease, the system 2504 may gradually revert to the standard viewing experience, ensuring minimal impact on latency.

The sequence includes a spectator 2502 (e.g., a user device for spectators), and a system 2504 (e.g., a Twitch server), a biometric device 2506 (e.g., a smartwatch), and a cloud rendering engine 2508. The system 2504 receives watching live video game stream 2510 and activates biometric monitoring 2512 from the biometric device 2506 causing the biometric data to be transmitted back 2514 to the system 2504. During gameplay, the system receives biometric data 2516 and analyzes the data for signs of discomfort (e.g., elevated heart rate) 2518. If detected, the system 2504 may trigger adaptive response to reduce motion effects 2520 and receive a modified video setting 2522 from the cloud rendering engine 2508. This modified stream is transmitted 2524 from the system 2504 to the spectator 2502. Alternatively, the stream may continue with standard video settings 2526. If discomfort decreases, the system may gradually revert to standard video settings 2528 and restore the original configuration 2530 to deliver the standard viewing experience 2532.

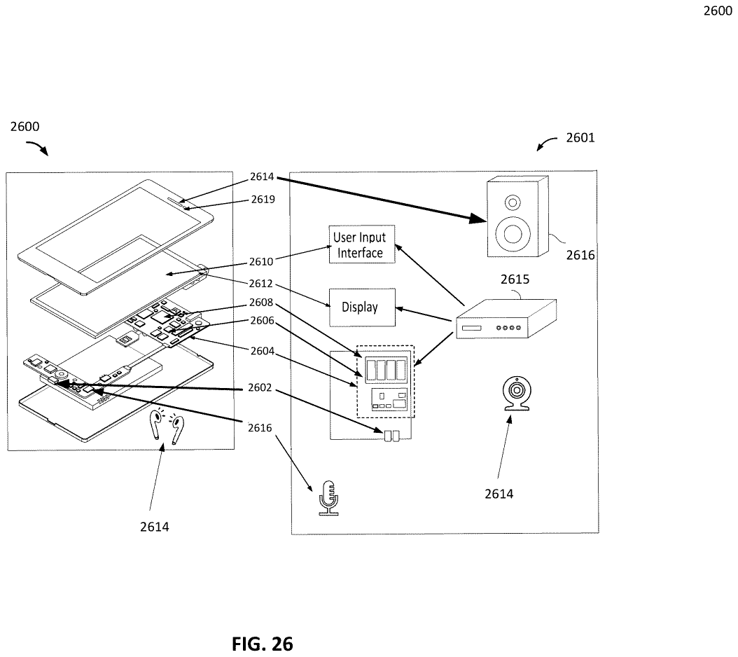

FIGS. 26-27 describe illustrative devices, systems, servers, and related hardware for a media application for efficient navigation of a plurality of media assets and for playing post-credit content in media assets by overriding play-next logic, in accordance with some embodiments of this disclosure. FIG. 26 shows generalized embodiments of illustrative user devices 2600 and 2601. For example, user equipment device 2600 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 2601 may be a user television equipment system or device. User television equipment device 2601 may include set-top box 2615. Set-top box 2615 may be communicatively connected to microphone 2616, audio output equipment (e.g., speaker or headphones 2614), and display 2612. In some embodiments, microphone 2616 may receive audio corresponding to a voice of a user, e.g., a voice command. In some embodiments, display 2612 may be a television display or a computer display. In some embodiments, set-top box 2615 may be communicatively connected to user input interface 2610. In some embodiments, user input interface 2610 may be a remote control device. Set-top box 2615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 10. In some embodiments, device 2600 may comprise any suitable number of sensors, as well as a GPS module (e.g., in communication with one or more servers and/or cell towers and/or satellites) to ascertain a location of device 2600.

Each one of user equipment device 2600 and user equipment device 2601 may receive content and data via input/output (I/O) path 2602. I/O path 2602 may provide content (e.g., broadcast programming, on-demand programming, Internet content, content available over a local area network (LAN) or wide area network (WAN), and/or other content) and data to control circuitry 2604, which may comprise processing circuitry 2606 and storage 2608. Control circuitry 2604 may be used to send and receive commands, requests, and other suitable data using I/O path 2602, which may comprise I/O circuitry. I/O path 2602 may connect control circuitry 2604 (and specifically processing circuitry 2606) to one or more communications paths (described below). I/O functions may be provided by one or more of these communications paths, but are shown as a single path in FIG. 10 to avoid overcomplicating the drawing. While set-top box 2615 is shown in FIG. 10 for illustration, any suitable computing device having processing circuitry, control circuitry, and storage may be used in accordance with the present disclosure. For example, set-top box 2615 may be replaced by, or complemented by, a personal computer (e.g., a notebook, a laptop, a desktop), a smartphone (e.g., device 2600), a tablet, a network-based server hosting a user-accessible user device, a non-user-owned device, any other suitable device, or any combination thereof.

Control circuitry 2604 may be based on any suitable control circuitry such as processing circuitry 2606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 2604 executes instructions for the Media application stored in memory (e.g., storage 2608). Specifically, control circuitry 2604 may be instructed by the Media application to perform the functions discussed above and below. In some implementations, processing or actions performed by control circuitry 2604 may be based on instructions received from the Media application.

In client/server-based embodiments, control circuitry 2604 may include communications circuitry suitable for communicating with a server or other networks or servers. The media application may be a stand-alone application implemented on a device or a server.

The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 27, the instructions may be stored in storage 2608 and executed by control circuitry 2604 of a device 2600.

In some embodiments, the media application may be a client/server application where only the client application resides on device 2600, and a server application resides on an external server (e.g., server 2704). For example, the media application may be implemented partially as a client application on control circuitry 2604 of device 2600 and partially on server 2704 as a server application running on control circuitry 2711. Server 2704 may be a part of a local area network with one or more of devices 2600 or may be part of a cloud computing environment accessed via the internet. In a cloud computing environment, various types of computing services for performing searches on the internet or informational databases, providing storage (e.g., for a database 2705) or parsing data are provided by a collection of network-accessible computing and storage resources (e.g., server 2704), referred to as “the cloud.” Device 2600 may be a cloud client that relies on the cloud computing capabilities from server 2704 to determine whether processing should be offloaded and facilitate such offloading. When executed by control circuitry 2604 or 2711, the media application may instruct control circuitry 2604 or 2711 circuitry to perform processing tasks for the user device and facilitate a media consumption session integrated with social network services. The client application may instruct control circuitry 2604 to determine whether processing should be offloaded.

Control circuitry 2604 may include communications circuitry suitable for communicating with a server, social network service, a table or database server, or other networks or servers. The instructions for carrying out the above-mentioned functionality may be stored on a server (which is described in more detail in connection with FIG. 10).

Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of user equipment devices, or communication of user equipment devices in locations remote from each other (described in more detail below).

Memory may be an electronic storage device provided as storage 2608 that is part of control circuitry 2604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 2608 may be used to store various types of content described herein as well as media application data described above. Nonvolatile memory may also be used (e.g., to launch a boot-up routine and other instructions). Cloud-based storage may be used to supplement storage 2608 or instead of storage 2608.

Control circuitry 2604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 2604 may also include scaler circuitry for upconverting and down converting content into the preferred output format of user equipment 2600. Control circuitry 2604 may also include digital-to-analog converter circuitry and analog-to-digital converter circuitry for converting between digital and analog signals. The tuning and encoding circuitry may be used by user equipment device 2600, 2601 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 2608 is provided as a separate device from user equipment device 2600, the tuning and encoding circuitry (including multiple tuners) may be associated with storage 2608.

Control circuitry 2604 may receive instruction from a user by way of user input interface 2610. User input interface 2610 may be any suitable user interface, such as a remote control, mouse, trackball, keypad, keyboard, touch screen, touchpad, stylus input, joystick, voice recognition interface, or other user input interfaces. Display 2612 may be provided as a stand-alone device or integrated with other elements of each one of user equipment device 2600 and user equipment device 2601. For example, display 2612 may be a touchscreen or touch-sensitive display. In such circumstances, user input interface 2610 may be integrated with or combined with display 2612. In some embodiments, user input interface 2610 includes a remote-control device having one or more microphones, buttons, keypads, any other components configured to receive user input or combinations thereof. For example, user input interface 2610 may include a handheld remote-control device having an alphanumeric keypad and option buttons. In a further example, user input interface 2610 may include a handheld remote-control device having a microphone and control circuitry configured to receive and identify voice commands and transmit information to set-top box 2615.

Audio output equipment 2614 may be integrated with or combined with display 2612. Display 2612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 2612. Audio output equipment 2614 may be provided as integrated with other elements of each one of device 2600 and equipment 2601 or may be stand-alone units. An audio component of videos and other content displayed on display 2612 may be played through speakers (or headphones) of audio output equipment 2614. In some embodiments, audio may be distributed to a receiver (not shown), which processes and outputs the audio via speakers of audio output equipment 2614. In some embodiments, for example, control circuitry 2604 is configured to provide audio cues to a user, or other audio feedback to a user, using speakers of audio output equipment 2614. There may be a separate microphone 2616 or audio output equipment 2614 may include a microphone configured to receive audio input such as voice commands or speech. For example, a user may speak letters or words that are received by the microphone and converted to text by control circuitry 2604. In a further example, a user may voice commands that are received by a microphone and recognized by control circuitry 2604. Camera 2618 may be any suitable video camera integrated with the equipment or externally connected. Camera 2618 may be a digital camera comprising a charge-coupled device (CCD) and/or a complementary metal-oxide semiconductor (CMOS) image sensor. Camera 2618 may be an analog camera that converts to digital images via a video card.

The media application may be implemented using any suitable architecture. For example, it may be a stand-alone application wholly-implemented on each one of user equipment device 2600 and user equipment device 2601. In such an approach, instructions of the application may be stored locally (e.g., in storage 2608), and data for use by the application is downloaded on a periodic basis (e.g., from an out-of-band feed, from an Internet resource, or using another suitable approach). Control circuitry 2604 may retrieve instructions of the application from storage 2608 and process the instructions to provide media consumption and social network interaction functionality and generate any of the displays discussed herein. Based on the processed instructions, control circuitry 2604 may determine what action to perform when input is received from user input interface 2610. For example, movement of a cursor on a display up/down may be indicated by the processed instructions when user input interface 2610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 2604 may allow a user to provide user profile information or may automatically compile user profile information. For example, control circuitry 2604 may access and monitor network data, video data, audio data, processing data, participation data from a media application and social network profile. Control circuitry 2604 may obtain all or part of other user profiles that are related to a particular user (e.g., via social media networks), and/or obtain information about the user from other sources that control circuitry 2604 may access. As a result, a user can be provided with a unified experience across the user's different devices.

In some embodiments, the media application is a client/server-based application. Data for use by a thick or thin client implemented on each one of user equipment device 2600 and user equipment device 2601 may be retrieved on-demand by issuing requests to a server remote to each one of user equipment device 2600 and user equipment device 2601. For example, the remote server may store the instructions for the application in a storage device. The remote server may process the stored instructions using circuitry (e.g., control circuitry 2604) and generate the displays discussed above and below. The user device may receive the displays generated by the remote server and may display the content of the displays locally on device 2600. This way, the processing of the instructions is performed remotely by the server while the resulting displays (e.g., that may include text, a keyboard, or other visuals) are provided locally on device 2600. Device 2600 may receive inputs from the user via input interface 2610 and transmit those inputs to the remote server for processing and generating the corresponding displays. For example, device 2600 may transmit a communication to the remote server indicating that an up/down button was selected via input interface 2610. The remote server may process instructions in accordance with that input and generate a display of the application corresponding to the input (e.g., a display that moves a cursor up/down). The generated display may then be transmitted to device 2600 for presentation to the user.

In some embodiments, the media application may be downloaded and interpreted or otherwise run by an interpreter or virtual machine (run by control circuitry 2604). In some embodiments, the media application may be encoded in the ETV Binary Interchange Format (EBIF), received by control circuitry 2604 as part of a suitable feed, and interpreted by a user agent running on control circuitry 2604. For example, the media application may be an EBIF application. In some embodiments, the media application may be defined by a series of JAVA-based files that are received and run by a local virtual machine or other suitable middleware executed by control circuitry 2604. In some of such embodiments (e.g., those employing MPEG-2 or other digital media encoding schemes), the media application may be, for example, encoded and transmitted in an MPEG-2 object carousel with the MPEG audio and video packets of a program.

FIG. 27 is a diagram of an illustrative system 2700, in accordance with some embodiments of this disclosure. User equipment devices 2707, 2708, 2709, 2710 may be coupled to communication network 2706. Communication network 2706 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 2706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the user devices may be provided by one or more of these communications paths but are shown as a single path in FIG. 27 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 2702-11x, etc.), or other short-range communication via wired or wireless paths. The user equipment devices may also communicate with each other directly through an indirect path via communication network 2706.

System 2700 may comprise media content source 2702, one or more servers 2704, and one or more social network services. In some embodiments, the media application may be executed at one or more of control circuitry 2711 of server 2704 (and/or control circuitry of user equipment devices 2707, 2708, 2709, 2710.

In some embodiments, server 2704 may include control circuitry 2711 and storage 2714 (e.g., RAM, ROM, Hard Disk, Removable Disk, etc.). Instructions for the media application may be stored in storage 2714. Storage 2714 may store one or more databases. Server 2704 may also include an input/output path 2712. I/O path 2712 may provide media consumption data, social media data, device information, or other data, over a local area network (LAN) or wide area network (WAN), and/or other content and data to control circuitry 2711, which may include processing circuitry, and storage 2714. Control circuitry 2711 may be used to send and receive commands, requests, and other suitable data using I/O path 2712, which may comprise I/O circuitry. I/O path 2712 may connect control circuitry 2711 (and specifically control circuitry) to one or more communications paths. I/O path 2712 may comprise I/O circuitry.

Control circuitry 2711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 2711 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 2711 executes instructions for an emulation system application stored in memory (e.g., the storage 2714). Memory may be an electronic storage device provided as storage 2714 that is part of control circuitry 2711.

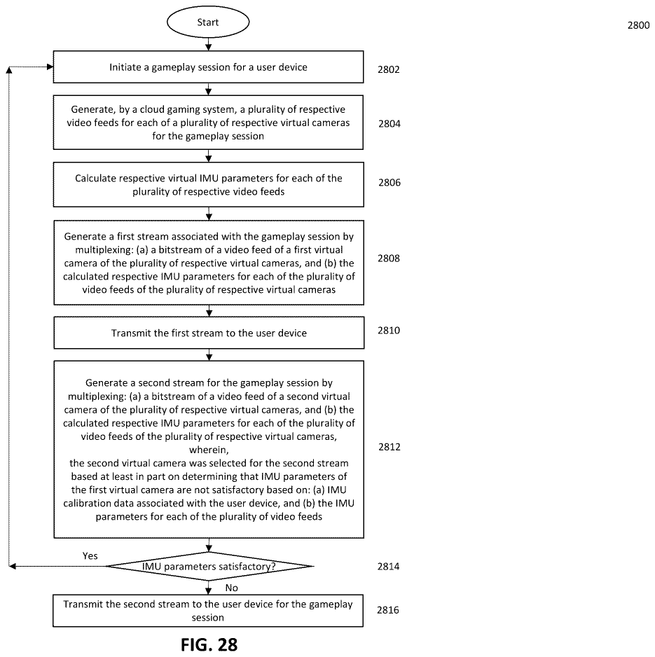

FIG. 28 is a flowchart of a detailed illustrative process 2800 for generating a second stream for the gameplay session, in accordance with some embodiments of this disclosure. In various embodiments, the individual steps of process 2800 may be implemented by one or more components of the devices and systems of FIGS. 1-27 (e.g., the game server of FIGS. 1A-C).

Although the present disclosure may describe certain steps of process 2800 (and of other processes described herein) as being implemented by certain components of the devices and systems of FIGS. 1-27, this is for purposes of illustration only, and it should be understood that other components of the devices and systems of FIGS. 1-27 may implement those steps instead.

At 2802, the game server, via a control circuitry (e.g., control circuitry 2711 of FIG. 27), initiate a gameplay session for a user device (e.g., similar to FIG. 1A at 116). The gameplay session may be initiated via an I/O path (e.g., I/O path 2712) over a communication network (e.g., communication network 2706).

At 2804, the game server, via a control circuitry, generates, by a cloud gaming system, a plurality of respective video feeds for each of a plurality of respective virtual cameras for the gameplay session (e.g., similar to FIG. 1A at 106, 108, and 110 having multiple video feeds).

The cloud gaming system may be media content source 2728 of FIG. 27 or another server connected over the communication network.

At 2806, the game server, via a control circuitry, may calculate respective virtual IMU parameters for each of the plurality of respective video feeds (e.g., similar to FIG. 1A at 112).

At 2808, the game server, via a control circuitry, may generate a first stream associated with the gameplay session by multiplexing: (a) a bitstream of a video feed of a first virtual camera of the plurality of respective virtual cameras, and (b) the calculated respective IMU parameters for each of the plurality of video feeds of the plurality of respective virtual cameras (e.g., similar to FIG. 1A at 112).

At 2810, the game server, via a control circuitry, transmits the first stream to the user device. The transmission may take place over the communications network. In some embodiments, the user device may be any of user equipment 2707, 2708, 2709, and 2710.

At 2812, the game server, via a control circuitry, generates a second stream for the gameplay session by multiplexing: (a) a bitstream of a video feed of a second virtual camera of the plurality of respective virtual cameras, and (b) the calculated respective IMU parameters for each of the plurality of video feeds of the plurality of respective virtual cameras. The second virtual camera is selected for the second stream based at least in part on determining that IMU parameters of the first virtual camera are not satisfactory based on: (a) IMU calibration data associated with the user device, and (b) the IMU parameters for each of the plurality of video feeds (e.g., similar to FIG. 1C where a third-person video feed is selected as the second stream).

At 2814, the game server, via a control circuitry, determines whether the IMU parameters are satisfactory. If a determination is made that the IMU parameters are not satisfactory, the process reverts to 2802. If a determination is made that the IMU parameters are satisfactory, the process continues to 2816. At 2816, the game server, via a control circuitry, transmits the second stream to the user device for the gameplay session (e.g., similar to FIG. 1C at 132).

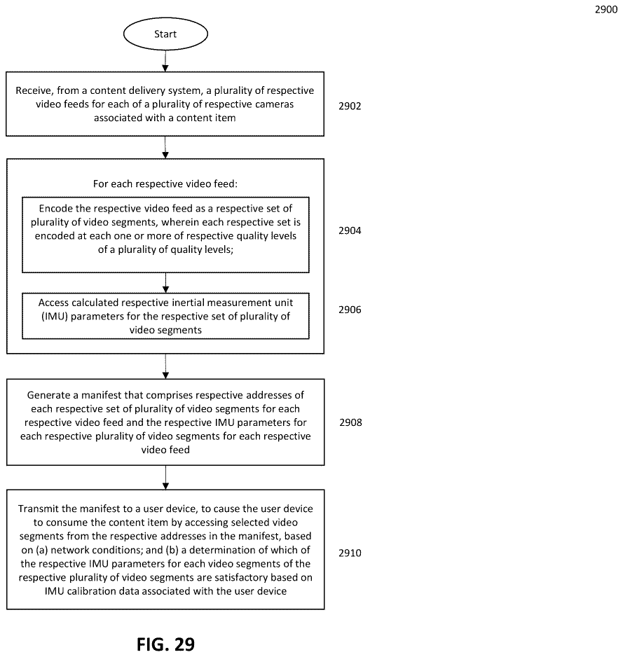

FIG. 29 is a flowchart of a detailed illustrative process 2900 for accessing selected video segments from the respective addresses in a manifest, in accordance with some embodiments of this disclosure. At 2902, a streaming server, via a control circuitry, receives, from a content delivery system, a plurality of respective video feeds for each of a plurality of respective cameras associated with a content item (e.g., similar to FIG. 2A receiving video feeds 206, 208, and 210).

At 2904, the streaming server, via a control circuitry, for each video feed, encodes the respective video feed as a respective set of the plurality of video segments. Each respective set is encoded at each one or more of respective quality levels of a plurality of quality levels (e.g., similar to FIG. 2B at 222-224).

At 2906, the streaming server, via a control circuitry, for each video feed, accesses calculated respective inertial measurement unit (IMU) parameters for the respective set of the plurality of video segments (e.g., similar to FIG. 2B at 222-224).

At 2908, the streaming server, via a control circuitry, generates a manifest that comprises respective addresses of each respective set of the plurality of video segments for each respective video feed and the respective IMU parameters for each respective plurality of video segments for each respective video feed (e.g., similar to FIG. 2B at 224).

At 2910, the streaming server, via a control circuitry, transmits the manifest to a user device, to cause the user device to consume the content item by accessing selected video segments from the respective addresses in the manifest, based on (a) network conditions; and (b) a determination of which of the respective IMU parameters for each video segments of the respective plurality of video segments are satisfactory based on IMU calibration data associated with the user device (e.g., similar to FIG. 2C at 238).

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from a content delivery system, a plurality of respective video feeds for each of a plurality of respective cameras associated with a content item;
for each respective video feed:
encoding the respective video feed as a respective set of plurality of video segments, wherein each respective set is encoded at one or more of respective quality levels of a plurality of quality levels;
accessing calculated respective inertial measurement unit (IMU) parameters for the respective set of plurality of video segments; and
generating a manifest file that comprises:
respective address data for each of the respective set of plurality of video segments for each respective video feed; and
the respective IMU parameters for each respective plurality of video segments for each respective video feed;
transmitting the manifest to a user device, to cause the user device to consume the content item by:
accessing selected video segments from the respective URLs in the manifest, based on:
(a) network conditions; and
(b) a determination of which of the respective IMU parameters for each video segment of the respective plurality of video segments are satisfactory based on IMU calibration data associated with the user device.

2. The method of claim 1, wherein the plurality of quality levels comprises at least one of: plurality of bitrates, plurality of resolutions, plurality of frame rates, plurality of compressions depths, plurality of color depths, plurality of aspect ratios, or plurality of codecs.

3. The method of claim 1, wherein the content item comprises a stream of a gameplay session associated with a gamer device, and wherein the plurality of respective cameras comprises one or more virtual cameras of vantage points of the gameplay session.

4. The method of claim 3, wherein the one or more vantage points comprise at least one of: first-person perspective, third-person perspective, chase camera perspective, free-roam perspective, fixed-camera angle perspective, isometric perspective, or top-down perspective.

5. The method of claim 1, wherein the content item comprises a stream of a live event, and wherein the plurality of respective cameras comprises a plurality of physical cameras capturing the live event from multiple physical locations.

6. The method of claim 1, wherein the determination of which of the calculated IMU parameters for each of the video segments of the respective plurality of video segments are satisfactory based on IMU calibration data associated with the user device comprises:
determining at least one sensitivity setting for the user device, wherein the at least one sensitivity setting for the user device indicates visual characteristics that are indicated as not satisfactory; and
determining that calculated IMU parameters for the selected video segments match the at least one sensitivity setting for the user device.

7. The method of claim 6, wherein the determining the at least one sensitivity setting for the user device comprises:
generating for display a calibration video, wherein the calibration video comprises depictions of a plurality of motion types;
receiving biometric data while generating for display the calibration video; and
determining the at least one sensitivity setting for the user device based on at least the received biometric data exceeding a sensitivity threshold.

8. The method of claim 1, wherein each calculated IMU parameters for the respective set of plurality of video segments comprises calculated IMU parameters for each segment of the respective set of plurality of video segments.

9. The method of claim 8, wherein the calculated IMU parameters for each segment of the respective set of plurality of video segments comprise at least one of: an average value of IMU parameters for a respective segment, a highest value of IMU parameters for the respective segment, or a median value of IMU parameters for the respective segment.

10. The method of claim 1, wherein the calculated IMU parameters comprise at least one of: linear acceleration, angular velocity, or orientation.

11. A system comprising:
control circuitry configured to:
receive, from a content delivery system, a plurality of respective video feeds for each of a plurality of respective cameras associated with a content item;
for each respective video feed:
encode the respective video feed as a respective set of plurality of video segments, wherein each respective set is encoded at one or more of respective quality levels of a plurality of quality levels;
access calculated respective inertial measurement unit (IMU) parameters for the respective set of plurality of video segments; and
generate a manifest file that comprises:
respective address data for each of the respective set of plurality of video segments for each respective video feed; and
the respective IMU parameters for each respective plurality of video segments for each respective video feed;
transmit the manifest to a user device, to cause the user device to consume the content item by:
accessing selected video segments from the respective URLs in the manifest, based on:
(a) network conditions; and
(b) a determination of which of the respective IMU parameters for each video segment of the respective plurality of video segments are satisfactory based on IMU calibration data associated with the user device.

12. The system of claim 11, wherein the plurality of quality levels comprises at least one of: plurality of bitrates, plurality of resolutions, plurality of frame rates, plurality of compressions depths, plurality of color depths, plurality of aspect ratios, or plurality of codecs.

13. The system of claim 11, wherein the content item comprises a stream of a gameplay session associated with a gamer device, and wherein the plurality of respective cameras comprises one or more virtual cameras of vantage points of the gameplay session.

14. The system of claim 13, wherein the one or more vantage points comprise at least one of: first-person perspective, third-person perspective, chase camera perspective, free-roam perspective, fixed-camera angle perspective, isometric perspective, or top-down perspective.

15. The system of claim 11, wherein the content item comprises a stream of a live event, and wherein the plurality of respective cameras comprises a plurality of physical cameras capturing the live event from multiple physical locations.

16. The system of claim 11, wherein the system is configured, when determining which of the calculated IMU parameters for each of the video segments of the respective plurality of video segments are satisfactory based on IMU calibration data associated with the user device, to:
determine at least one sensitivity setting for the user device, wherein the at least one sensitivity setting for the user device indicates visual characteristics that are indicated as not satisfactory; and
determine that calculated IMU parameters for the selected video segments match the at least one sensitivity setting for the user device.

17. The system of claim 16, wherein the system is configured, when determining the at least one sensitivity setting for the user device, to:
generate for display a calibration video, wherein the calibration video comprises depictions of a plurality of motion types;
receive biometric data while generating for display the calibration video; and
determine the at least one sensitivity setting for the user device based on at least the received biometric data exceeding a sensitivity threshold.

18. The system of claim 11, wherein each calculated IMU parameters for the respective set of plurality of video segments comprises calculated IMU parameters for each segment of the respective set of plurality of video segments.

19. The system of claim 18, wherein the calculated IMU parameters for each segment of the respective set of plurality of video segments comprise at least one of: an average value of IMU parameters for a respective segment, a highest value of IMU parameters for the respective segment, or a median value of IMU parameters for the respective segment.

20. The system of claim 11, wherein the calculated IMU parameters comprise at least one of: linear acceleration, angular velocity, or orientation.

21.-50. (canceled)
